(19) United States
(12) Patent Application Publication
(10) Pub. No.: US 2009/0092746 A1
(43) Pub. Date: Apr. 9, 2009

(54) PHOTOREFRACTIVE COMPOSITIONS WITH NANOPARTICLES

(75) Inventors: Tao Gu, San Diego, CA (US); Peng Wang, San Diego, CA (US)

Correspondence Address: KNOBBE MARTENS OLSON & BEAR LLP, 2040 MAIN STREET, FOURTEENTH FLOOR, IRVINE, CA, 92614, US

(73) Assignee: Nitto Denko Corporation, Osaka (JP)

(21) Appl. No.: 12/243,268

(22) Filed: Oct. 1, 2008

Related U.S. Application Data
(60) Provisional application No. 60/977,019, filed on Oct. 2, 2007.

(51) Int. Cl. B05D 5/12; H01B 1/12

(52) U.S. Cl. 427/74; 252/501.1

(57) ABSTRACT

Described herein are photorefractive compositions and devices incorporating such compositions. The photorefractive composition comprises a polymer and metal-containing nanoparticles. The polymer comprises a charge transport component and a non-linear optical component which provides non-linear optical functionality. Optionally, the composition can further comprise at least one agent which inhibits agglomeration of the nanoparticles, as well as other components such as sensitizers and plasticizers. The photorefractive compositions demonstrate very good phase stabilities and substantially no haziness, even after several months. Furthermore, the addition of the metal compound nanoparticles to the polymer increases the photorefractive response time and grating formation speed when compared to similar compositions that do not contain the nanoparticles.

### CROSS-REFERENCE TO RELATED APPLICATIONS

This application claims priority to U.S. Provisional Application No. 60/977,019, entitled “PHOTOREFRACTIVE COMPOSITIONS WITH NANOPARTICLES,” filed on Oct. 2, 2007, the contents of which are incorporated herein by reference in their entirety.

### BACKGROUND OF THE INVENTION

1. Field of the Invention

Described herein are photorefractive compositions that comprise a photorefractive polymer. In an embodiment, the photorefractive composition comprises nanoparticles distributed among the photorefractive polymer, wherein the nanoparticles comprise metal, metal oxide, and/or metal alloy.

2. Description of the Related Art

Photorefractivity is a phenomenon in which the refractive index of a material can be altered by changing the electric field within the material, such as by laser beam irradiation. The change of the refractive index is achieved by a mechanistic pathway including: (1) charge generation by laser irradiation, (2) charge transport, resulting in the separation of positive and negative charges, and (3) trapping of one type of charge (charge delocalization), (4) formation of a non-uniform internal electric field (space-charge field) as a result of charge delocalization, and (5) refractive index change induced by the non-uniform electric field.

Therefore, good photorefractive properties can generally be seen in materials that combine good charge generation, good charge transport (also known as photoconductivity), and good electro-optical activity. Photorefractive materials have many promising applications, such as high-density optical data storage, dynamic holography, optical image processing, phase conjugated mirrors, optical computing, parallel optical logic, and pattern recognition.

Originally, the photorefractive effect was found in a variety of inorganic electro-optical (EO) crystals, such as LiNbO₃. In these materials, the mechanism of the refractive index modulation by the internal space-charge field is based on a linear electro-optical effect. Inorganic EO crystals typically do not require biased voltage to exhibit the photorefractive behavior.

In 1990 and 1991, the first organic photorefractive crystal and polymeric photorefractive materials were discovered and reported. Such materials are disclosed, for example, in U.S. Pat. No. 5,064,264, to Ducharme et al, hereby incorporated by reference in its entirety. Organic photorefractive materials offer many advantages over the inorganic photorefractive crystals, such as large optical non-linearities, low dielectric constants, lower costs, lighter weight, structural flexibility, and ease of device fabrication. Other important characteristics that may be desirable, depending on the application, include longer shelf life, optical quality, and thermal stability. These kinds of active organic polymers are emerging as key materials for advanced information and telecommunication technology.

In recent years, efforts have been made to optimize the properties of organic, and particularly polymeric, photorefractive materials. Various studies have been performed to examine the selection and combination of the components that give rise to the features of charge generation, photoconductivity, and electro-optical activity. Incorporation of material containing carbazole groups helps improve the photoconductive capability of a composition. Additionally, incorporation of phenyl amine groups can also improve the charge transport of a material.

However, the combination of fast response times, high diffraction efficiency, and low use of biased voltage in these materials remain a facet that can still be improved upon. In particular, there remains a need for photorefractive compositions that possess fast response times that can be used with reasonably low biased voltages applied for data or image storage purposes.

### SUMMARY OF THE INVENTION

Embodiments of the present disclosure provide a photorefractive composition. In an embodiment, the photorefractive composition comprises a polymer and metal-containing nanoparticles. In an embodiment, the polymer comprises a charge transport component and a non-linear optical component.

In some embodiments, the metal-containing nanoparticles comprise at least one metal of gold, palladium, platinum, silver, copper, and mixtures thereof. In some embodiments, the metal-containing nanoparticles comprise at least oxide of gold, palladium, platinum, silver, copper, and mixtures thereof. In some embodiments, the metal-containing nanoparticles comprise at least alloy of gold, palladium, platinum, silver, copper, and mixtures thereof In some embodiments, the metal-containing nanoparticles comprise gold or a gold alloy.

In an embodiment, the metal-containing nanoparticles possess a diameter from about 0.1 nm to about 100 nm. In an embodiment, the metal-containing nanoparticles possess a diameter which is less than about 10 nm. In an embodiment, the metal-containing nanoparticles possess a diameter which is less than about 9 nm. In an embodiment, the metal-containing nanoparticles possess a diameter which is less than about 8 nm. In an embodiment, the metal-containing nanoparticles possess a diameter which is less than about 7 nm. In an embodiment, the metal-containing nanoparticles possess a diameter which is less than about 6 nm. In an embodiment, the metal-containing nanoparticles possess a diameter which is less than about 5 nm. In an embodiment, the metal-containing nanoparticles possess a diameter which is less than about 4 nm. In an embodiment, the metal-containing nanoparticles possess a diameter which is less than about 3 nm. In an embodiment, the metal-containing nanoparticles possess a diameter which is less than about 2 nm. In an embodiment, the metal-containing nanoparticles possess a diameter which is less than about 1 nm. In an embodiment, the metal-containing nanoparticles possess a diameter which is less than about 0.5 nm. In an embodiment, the metal-containing nanoparticles possess a diameter which is less than about 0.1 nm.

In an embodiment, the metal-containing nanoparticles are present in a concentration from about 0.0001 wt % to about 20 wt % on the basis of the weight of the total composition. In an embodiment, the metal-containing nanoparticles are present in a concentration greater than about 0.0001 wt % on the basis of the weight of the total composition. In an embodiment, the metal-containing nanoparticles are present in a concentration greater than about 0.001 wt % on the basis of the weight of the total composition. In an embodiment, the metal-containing nanoparticles are present in a concentration greater than about 0.01 wt % on the basis of the weight of the total composition. In an embodiment, the metal-containing nanoparticles are present in a concentration greater than about 0.1 wt % on the basis of the weight of the total composition. In an embodiment, the metal-containing nanoparticles are present in a concentration greater than about 0.5 wt % on the basis of the weight of the total composition. In an embodiment, the metal-containing nanoparticles are present in a concentration greater than about 1 wt % on the basis of the weight of the total composition. In an embodiment, the metal-containing nanoparticles are present in a concentration greater than about 2 wt % on the basis of the weight of the total composition. In an embodiment, the metal-containing nanoparticles are present in a concentration greater than about 3 wt % on the basis of the weight of the total composition. In an embodiment, the metal-containing nanoparticles are present in a concentration greater than about 4 wt % on the basis of the weight of the total composition. In an embodiment, the metal-containing nanoparticles are present in a concentration greater than about 5 wt % on the basis of the weight of the total composition.

In an embodiment, the composition further comprises an agent which inhibits agglomeration of the nanoparticles. In an embodiment, the agent comprises a sulfur containing ligand. In an embodiment, the sulfur containing ligand comprises a thiol.

In an embodiment, the charge transport component is non-covalently integrated into the polymer. In an embodiment, the charge transport component is attached to the polymer as a side chain. In an embodiment, charge transport component comprises a recurring unit that comprises a moiety selected from the group consisting of the Structures (i), (ii), and (iii):

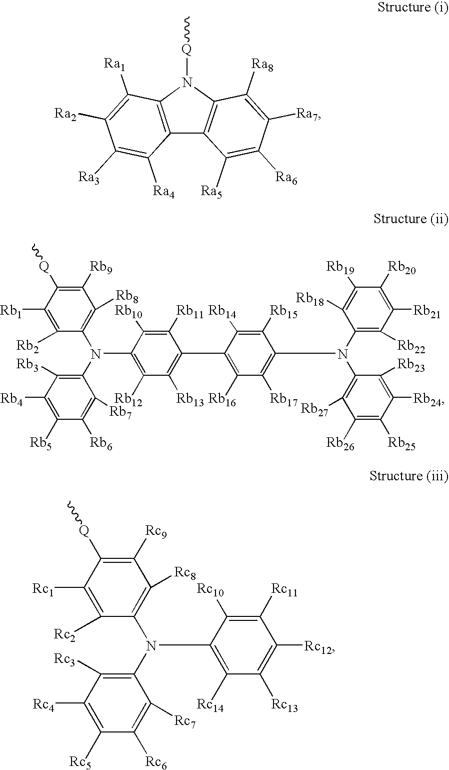

wherein each Q in Structures (i), (ii), and (iii) independently represents an alkylene group, with or without a hetero atom and Ra₁-Ra₈, Rb₁-Rb₂₇, and Rc₁-Rc₁₄ of Structures (i), (ii), and (iii) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In an embodiment, the non-linear optical component is non-covalently integrated into the polymer. In an embodiment, the non-linear optical component is attached to the polymer as a side chain. In an embodiment, the non-linear optical component comprises a recurring unit that comprises a moiety comprising Structure (0):

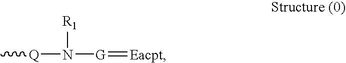

wherein Q in Structure (0) represents an alkylene group, with or without a hetero atom, G in Structure (0) is a group having a bridge of π-conjugated bond, Eacpt in Structure (0) is an electron acceptor group, and R₁ in Structure (0) is selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, G in Structure (0) is selected from the group consisting of the Structures (iv) and (v):

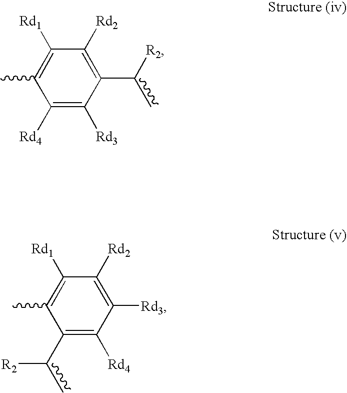

wherein each Rd₁-Rd₄ and R₂ in Structures (iv) and (v) are independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, Eacpt in Structure (0) is represented by a structure selected from the group consisting of the structures:

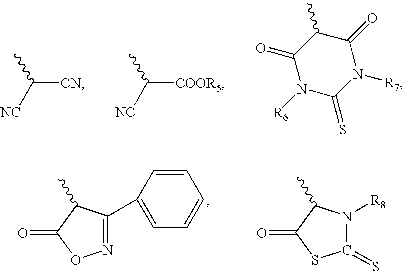

wherein R₅, R₆, R₇ and R₈ in the above compounds are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, the photorefractive composition demonstrates a response time of about 1 ms to about 100 ms. In an embodiment, the photorefractive composition demonstrates a response time which is less than about 90 ms. In an embodiment, the photorefractive composition demonstrates a response time which is less than about 80 ms. In an embodiment, the photorefractive composition demonstrates a response time which is less than about 70 ms. In an embodiment, the photorefractive composition demonstrates a response time which is less than about 60 ms. In an embodiment, the photorefractive composition demonstrates a response time which is less than about 50 ms. In an embodiment, the photorefractive composition demonstrates a response time which is less than about 40 ms. In an embodiment, the photorefractive composition demonstrates a response time which is less than about 30 ms. In an embodiment, the photorefractive composition demonstrates a response time which is less than about 20 ms. In an embodiment, the photorefractive composition demonstrates a response time which is less than about 10 ms. In an embodiment, the photorefractive composition demonstrates a response time which is less than about 5 ms. In an embodiment, the photorefractive composition demonstrates a response time which is less than about 1 ms.

An embodiment of the present disclosure provides a holographic data storage and image recording device comprising the photorefractive composition.

In some embodiments, there is provided a photorefractive composition, comprising nanoparticles comprising at least one of gold, palladium, platinum, silver, and copper and a first recurring unit including a first moiety selected from the group consisting of the Structures (i″), (ii″), and (iii″):

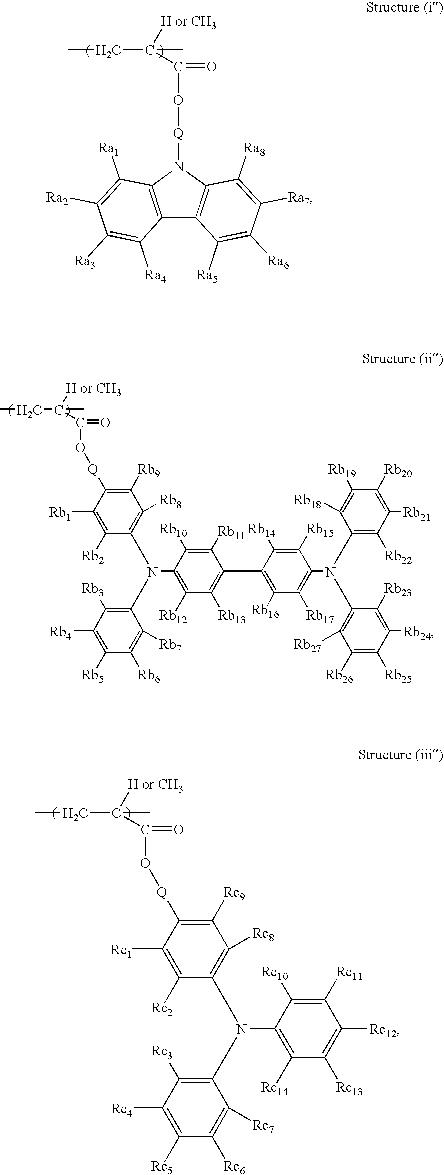

wherein each Q in Structures (i″), (ii″), and (iii″) independently represents an alkylene group, with or without a hetero atom and Ra₁-Ra₈, Rb₁-Rb₂₇, and Rc₁-Rc₁₄ in Structures (i″), (ii″), and (iii″) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In an embodiment, the photorefractive composition further comprises a second recurring unit comprising a second moiety represented by the Structure (0″):

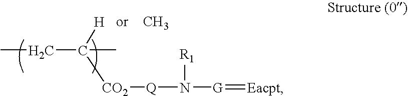

wherein Q in Structure (0″) represents an alkylene group, with or without a hetero atom, G in Structure (0″) is a group having a bridge of conjugated bond, Eacpt in Structure (0″) is an electron acceptor group, and R₁ in Structure (0″) is selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In other embodiments, G in Structure (0″) is selected from the group consisting of the Structures (iv) and (v):

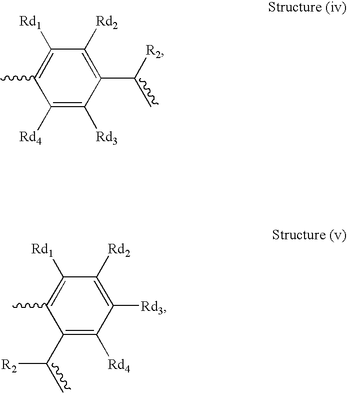

wherein Rd₁-Rd₄ and R₂ in Structures (iv) and (v) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, Eacpt in Structure (0″) is represented by a structure selected from the group consisting of the structures:

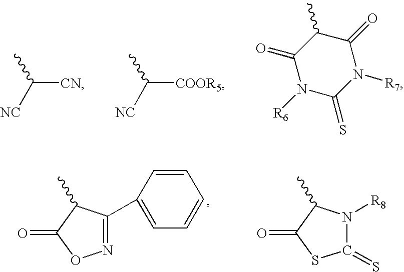

wherein R₅, R₆, R₇ and R₈ in the above compounds are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In an embodiment, there is provided a method of using a photorefractive composition. In an embodiment, the method of using a photorefractive composition comprises providing a photorefractive composition, where the composition comprises a polymer and metal-containing nanoparticles, wherein the polymer comprises a charge transport component and a non-linear optical component. In an embodiment, the method further comprises applying an electric field to a photorefractive composition. In an embodiment, the response time of the photorefractive composition achieves a selected response time for electric fields of approximately 100 V/μm or less, expressed as a biased voltage. In an embodiment, the electric field is less than about 90 V/μm. In an embodiment, the electric field is less than about 80V/μm.

Another embodiment provides an optical device. In an embodiment, the optical device comprises a photorefractive composition, metal-containing nanoparticles, and at least one optical substrate. In an embodiment, the photorefractive composition comprises a polymer. In an embodiment, the optical device comprises a plurality of optical substrates. The polymer can comprise a charge transport component and a non-linear optical component.

In an embodiment, the photorefractive composition is provided as a film and is adjacent to at least one optical substrate. In an embodiment, the film has a thickness of about 10 μm to about 200 μm. In an embodiment, the film has a thickness of about 200 μm. In an embodiment, the film has a thickness of about 180 μm. In an embodiment, the film has a thickness of about 160 μm. In an embodiment, the film has a thickness of about 140 μm. In an embodiment, the film has a thickness of about 120 μm. In an embodiment, the film has a thickness of about 100 μm. In an embodiment, the film has a thickness of about 80 μm. In an embodiment, the film has a thickness of about 60 μm. In an embodiment, the film has a thickness of about 50 μm. In an embodiment, the film has a thickness of about 40 μm. In an embodiment, the film has a thickness of about 30 μm. In an embodiment, the film has a thickness of about 20 μm. In an embodiment, the film has a thickness of about 10 μm.

In an embodiment, the optical device comprises a holographic data storage device.

In an embodiment, there is provided a method of manufacturing an optical device. In an embodiment, the method of manufacturing an optical device comprises providing an optical substrate and depositing a photorefractive composition on at least one surface of the substrate as a film. In an embodiment, the film has a thickness of about 10 μm to about 200 μm. In an embodiment, the film has a thickness of less than about 200 μm. In an embodiment, the film has a thickness of less than about 200 μm. In an embodiment, the film has a thickness of less than about 180 μm. In an embodiment, the film has a thickness of less than about 160 μm. In an embodiment, the film has a thickness of less than about 140 μm. In an embodiment, the film has a thickness of less than about 120 μm. In an embodiment, the film has a thickness of less than about 100 μm. In an embodiment, the film has a thickness of less than about 80 μm. In an embodiment, the film has a thickness of less than about 60 μm. In an embodiment, the film has a thickness of less than about 50 μm. In an embodiment, the film has a thickness of less than about 40 μm. In an embodiment, the film has a thickness of less than about 30 μm. In an embodiment, the film has a thickness of less than about 20 μm. In an embodiment, the film has a thickness of less than about 10 μm. In an embodiment, the photorefractive composition comprises a polymer. In an embodiment, the polymer comprises a charge transport component, a non-linear optical component, and metal-containing nanoparticles.

### DETAILED DESCRIPTION OF THE PREFERRED EMBODIMENT

Unless defined otherwise, all technical and scientific terms used herein have the same meaning as is commonly understood by one of ordinary skill in the art. All patents, applications, published applications, and other publications referenced herein are incorporated by reference in their entirety. In the event that there are a plurality of definitions for a term herein, those in this section prevail unless stated otherwise.

As used herein, “Cₘ₋ₙ” in which “m” and “n” are integers refers to the number of carbon atoms in an alkyl, alkenyl or alkynyl group or the number of carbon atoms in the ring of a cycloalkyl, cycloalkenyl, cycloalkynyl, aryl, heteroaryl or heteroalicyclyl group. That is, the alkyl, alkenyl, alkynyl, ring of the cycloalkyl, ring of the cycloalkenyl, ring of the cycloalkynyl, ring of the aryl, ring of the heteroaryl or ring of the heteroalicyclyl can contain from “m” to “n”, inclusive, carbon atoms. Thus, for example, a “C₁₋₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “m” and “n” are designated with regard to an alkyl, alkenyl, alkynyl, cycloalkyl cycloalkenyl, cycloalkynyl, aryl, heteroaryl or heteroalicyclyl group, the broadest range described in these definitions is to be assumed.

As used herein, “alkyl” refers to a straight or branched hydrocarbon chain fully saturated (no double or triple bonds) hydrocarbon group. The alkyl group may have 1 to 50 carbon atoms (whenever it appears herein, a numerical range such as “1 to 50” refers to each integer in the given range; e.g., “1 to 50 carbon atoms” means that the alkyl group may consist of 1 carbon atom, 2 carbon atoms, 3 carbon atoms, etc., up to and including 50 carbon atoms, although the present definition also covers the occurrence of the term “alkyl” where no numerical range is designated). The alkyl group may also be a medium size alkyl having 1 to 30 carbon atoms. Smaller alkyl groups can have 1 to 10 carbon atoms. The alkyl group could also be a lower alkyl having 1 to 5 carbon atoms. The alkyl group of the compounds may be designated as “C₁₋₄ alkyl” or similar designations. By way of example only, “C₁₋₄ alkyl” indicates that there are one to four carbon atoms in the alkyl chain, i.e., the alkyl chain is selected from the group consisting of methyl, ethyl, propyl, iso-propyl, n-butyl, iso-butyl, sec-butyl, and t-butyl. Typical alkyl groups include, but are in no way limited to, methyl, ethyl, propyl, isopropyl, butyl, isobutyl, tertiary butyl, pentyl, hexyl and the like.

The alkyl group may be substituted or unsubstituted. When substituted, the substituent group(s) is(are) one or more group(s) individually and independently selected from alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof.

As used herein, an “alkylene” refers to an alkyl group wherein one of the hydrogen atoms is removed to form a linking group. An alkylene group may include one or more heteroatoms, such as O, N, or S. An alklylene group may be unsubstituted or substituted. When substituted, the substituent(s) may be selected from the same groups disclosed above with regard to alkyl group substitution unless otherwise indicated.

As used herein, “alkenyl” refers to an alkyl group that contains in the straight or branched hydrocarbon chain one or more double bonds. An alkenyl group may be unsubstituted or substituted. When substituted, the substituent(s) may be selected from the same groups disclosed above with regard to alkyl group substitution unless otherwise indicated.

As used herein, “alkynyl” refers to an alkyl group that contains in the straight or branched hydrocarbon chain one or more triple bonds. An alkynyl group may be unsubstituted or substituted. When substituted, the substituent(s) may be selected from the same groups disclosed above with regard to alkyl group substitution unless otherwise indicated.

A “heteroalkyl” as used herein refers to an alkyl group as described herein in which one or more of the carbons atoms in the backbone of alkyl group has been replaced by a heteroatom such as nitrogen, sulfur and/or oxygen.

A “heteroalkenyl” as used herein refers to an alkenyl group as described herein in which one or more of the carbons atoms in the backbone of alkenyl group has been replaced by a heteroatom, for example, nitrogen, sulfur and/or oxygen.

A “heteroalkynyl” as used herein refers to an alkynyl group as described herein in which one or more of the carbons atoms in the backbone of alkynyl group has been replaced by a heteroatom such as nitrogen, sulfur and/or oxygen.

As used herein, “aryl” refers to a carbocyclic (all carbon) monocyclic or multicyclic aromatic ring system that has a fully delocalized pi-electron system. Examples of aryl groups include, but are not limited to, benzene, naphthalene and azulene. The ring of the aryl group may have 5 to 50 carbon atoms. The aryl group may be substituted or unsubstituted. When substituted, hydrogen atoms are replaced by substituent group(s) that is(are) one or more group(s) independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxy, alkoxy, aryloxy; acyl, ester, mercapto, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof, unless the substituent groups are otherwise indicated.

As used herein, “heteroaryl” refers to a monocyclic or multicyclic aromatic ring system (a ring system with fully delocalized pi-electron system) that contain(s) one or more heteroatoms, that is, an element other than carbon, including but not limited to, nitrogen, oxygen and sulfur. The ring of the heteroaryl group may have 5 to 50 atoms. The heteroaryl group may be substituted or unsubstituted. Examples of heteroaryl rings include, but are not limited to, furan, furazan, thiophene, benzothiophene, phthalazine, pyrrole, oxazole, benzoxazole, 1,2,3-oxadiazole, 1,2,4-oxadiazole, thiazole, 1,2,3-thiadiazole, 1,2,4-thiadiazole, benzothiazole, imidazole, benzimidazole, indole, indazole, pyrazole, benzopyrazole, isoxazole, benzoisoxazole, isothiazole, triazole, benzotriazole, thiadiazole, tetrazole, pyridine, pyridazine, pyrimidine, pyrazine, purine, pteridine, quinoline, isoquinoline, quinazoline, quinoxaline, cinnoline, and triazine. A heteroaryl group may be substituted or unsubstituted. When substituted, hydrogen atoms are replaced by substituent group(s) that is(are) one or more group(s) independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxy, alkoxy, aryloxy, acyl, ester, mercapto, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof.

As used herein, “cycloalkyl” refers to a completely saturated (no double bonds) mono- or multi-cyclic hydrocarbon ring system. When composed of two or more rings, the rings may be joined together in a fused, bridged or spiro-connected fashion. Cycloalkyl groups may range from C₃ to C₁₀, in other embodiments it may range from C₃ to C₈. A cycloalkyl group may be unsubstituted or substituted. Typical cycloalkyl groups include, but are in no way limited to, cyclopropyl, cyclobutyl, cyclopentyl, cyclohexyl, and the like. If substituted, the substituent(s) may be an alkyl or selected from those substituents indicated above with respect to substitution of an alkyl group unless otherwise indicated.

As used herein, “cycloalkenyl” refers to a cycloalkyl group that contains one or more double bonds in the ring although, if there is more than one, the double bonds cannot form a fully delocalized pi-electron system in the ring (otherwise the group would be “aryl,” as defined herein). When composed of two or more rings, the rings may be connected together in a fused, bridged or spiro-connected fashion. A cycloalkenyl group of may be unsubstituted or substituted. When substituted, the substituent(s) may be an alkyl or selected from the substituents disclosed above with respect to alkyl group substitution unless otherwise indicated.

As used herein, “cycloalkynyl” refers to a cycloalkyl group that contains one or more triple bonds in the ring. When composed of two or more rings, the rings may be joined together in a fused, bridged or spiro-connected fashion. A cycloalkynyl group may be unsubstituted or substituted. When substituted, the substituent(s) may be an alkyl or selected from the substituents disclosed above with respect to alkyl group substitution unless otherwise indicated.

As used herein, “heteroalicyclic” or “heteroalicyclyl” refers to a stable 3- to 18 membered ring which consists of carbon atoms and from one to five heteroatoms selected from the group consisting of nitrogen, oxygen and sulfur. The “heteroalicyclic” or “heteroalicyclyl” may be monocyclic, bicyclic, tricyclic, or tetracyclic ring system, which may be joined together in a fused, bridged or spiro-connected fashion; and the nitrogen, carbon and sulfur atoms in the “heteroalicyclic” or “heteroalicyclyl” may be optionally oxidized; the nitrogen may be optionally quaternized; and the rings may also contain one or more double bonds provided that they do not form a fully delocalized pi-electron system throughout all the rings. Heteroalicyclyl groups may be unsubstituted or substituted. When substituted, the substituent(s) may be one or more groups independently selected from the group consisting of alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, haloalkyl, haloalkoxy, trihalomethanesulfonyl, trihalomethanesulfonamido, and amino, including mono- and di-substituted amino groups, and the protected derivatives thereof. Examples of such “heteroalicyclic” or “heteroalicyclyl” include but are not limited to, azepinyl, acridinyl, carbazolyl, cinnolinyl, 1,3-dioxin, 1,3-dioxane, 1,4-dioxane, 1,2-dioxolanyl, 1,3-dioxolanyl, 1,4-dioxolanyl, 1,3-oxathiane, 1,4-oxathiin, 1,3-oxathiolane, 1,3-dithiole, 1,3-dithiolane, 1,4-oxathiane, tetrahydro-1,4-thiazine, 2H-1,2-oxazine, maleimide, succinimide, barbituric acid, thiobarbituric acid, dioxopiperazine, hydantoin, dihydrouracil, trioxane, hexahydro-1,3,5-triazine, imidazolinyl, imidazolidine, isoxazoline, isoxazolidine, oxazoline, oxazolidine, oxazolidinone, thiazoline, thiazolidine, morpholinyl, oxiranyl, piperidinyl N-Oxide, piperidinyl, piperazinyl, pyrrolidinyl, pyrrolidone, pyrrolidione, 4-piperidonyl, pyrazoline, pyrazolidinyl, 2-oxopyrrolidinyl, tetrahydropyran, 4H-pyran, tetrahydrothiopyran, thiamorpholinyl, thiamorpholinyl sulfoxide, thiamorpholinyl sulfone, and their benzo-fused analogs (e.g., benzimidazolidinone, tetrahydroquinoline, 3,4-methylenedioxyphenyl).

Whenever a group is described as being “optionally substituted” that group may be unsubstituted or substituted with one or more of the indicated substituents. Each of the groups described herein is considered optionally substituted unless indicated otherwise. Likewise, when a group is described as being “unsubstituted or substituted” if substituted, the substituent may be selected from one or more the indicated substituents. The protecting groups that may form the protective derivatives of the above substituents are known to those of skill in the art and may be found in references such as Greene and Wuts, Protective Groups in Organic Synthesis, 3^{rd} Ed., John Wiley & Sons, New York, N.Y., 1999, which is hereby incorporated by reference in its entirety.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures. In addition it is understood that, in any compound having one or more double bond(s) generating geometrical isomers that can be defined as E or Z each double bond may independently be E or Z a mixture thereof. Likewise, all tautomeric forms are also intended to be included.

The photorefractive compositions described herein are improved photorefractive compositions which exhibit beneficial characteristics such as fast response and decay times, high diffraction efficiency, and low applied biased voltage. In some embodiments, the photorefractive compositions comprise a photorefractive polymer matrix and particles of a metal-containing compound. In some embodiments, the composition comprises a polymer matrix that includes a component which provides photoconductive (charge transport) ability and a component that provides non-linear optical ability (e.g. a non-linear optical chromophore). In some embodiments, at least one of the charge transport and non-linear optical chromophore components is present as part of a compound which is not covalently integrated with the polymer matrix. In an embodiment, the composition includes other components, as necessary, including, but not limited to, sensitizer and plasticizer components.

The metal compound particles mixed with the polymer as provided herein increase the photo-conductivity and ease of charge distribution within the photorefractive compositions by providing good charge transport throughout the particle network. While not intending to be limited by the following, it is believed that these effects are accomplished due to the higher mobility and lower dependence on electric fields of the charge carriers in these particles over that of organics. As a result, the addition of the metal compound particles to the polymer composition increases the photorefractive response time and grating formation speed when compared to similar compositions without the particles. For example, as discussed in greater detail below in the Examples, response times of about 5.6 ms and erasing times of about 4.1 ms have been measured. This places compositions formed from embodiments of the present disclosure among some of the fastest photorefractive materials ever reported. These and other objects and advantages of the present disclosure are discussed in greater detail below.

In an embodiment, the metal-containing compound comprises metals, metal oxides, metal alloys, and mixtures thereof. Examples of the metal-containing compound include, but are not limited to, gold, palladium, platinum, silver, and copper. The metals can be used singly or in combination. In an embodiment, the metal-containing compound comprises gold, oxides of gold, alloys of gold, or a combination thereof. In an embodiment, the metal-containing compound comprises palladium, oxides of palladium, alloys of palladium, or a combination thereof. In an embodiment, the metal-containing compound comprises platinum, oxides of platinum, alloys of platinum, or a combination thereof. In an embodiment, the metal-containing compound comprises silver, oxides of silver, alloys of silver, or a combination thereof. In an embodiment, the metal-containing compound comprises copper, oxides of copper, alloys of copper, or a combination thereof. Furthermore, any combination of gold, palladium, platinum, silver, copper, their respective oxides, and their respective alloys can be combined and used as the metal-containing compound.

In some embodiments, the metal compound is provided in the form of nanoparticles. The term “nanoparticle” is used herein as it is known in the art and typically refers to particles having at least one dimension less than about 100 nanometers (nm).

The nanoparticles provided herein can be dispersed approximately uniformly throughout the polymer. In some embodiments, the particles are dispersed such that the compositions formed using the nanoparticles, as described in greater detail below, demonstrate substantially homogeneous optical properties. In some embodiments, the nanoparticles are substantially evenly dispersed such that compositions formed with the nanoparticles demonstrate selected properties based upon the teachings provided herein as understood by one of skill in the art.

Dispersing the nanoparticles can be performed using a variety of mechanisms. In an embodiment, the nanoparticles are dispersed through mechanical mixing of the particles and the polymer matrix. In an embodiment, ultrasonic energy may be applied to a mixture of nanoparticles and the polymer matrix to disperse the nanoparticles. In an embodiment, the nanoparticles are dispersed within the polymer matrix using electric fields. Provided in such a dispersed configuration, metal compound nanoparticles improve the photo-conductivity and ease of charge distribution within the photorefractive compositions by providing a substantially even distribution of charge transport throughout the polymer.

In some cases, the nanoparticles may have a propensity to aggregate and precipitate out of solution, resulting in a non-uniform dispersion of the nanoparticles and leading to a loss of the desired effects of the nanoparticles. To inhibit aggregation, the nanoparticles can be surrounded by a surface protective layer. The surface protective layer can comprise a wide variety of molecules or combinations thereof which inhibit nanoparticle aggregation. In some embodiments the molecules comprise organic and/or inorganic compounds which can be chemically or physically bound to the nanoparticle core, depending on the properties of the materials selected. Methods of bonding are well-known in the art, including but not limited to covalent and ionic bonding, as well as physical adsorption.

In an embodiment, the molecules of the surface protective layer are not be bound to the nanoparticles as described above. Rather, the molecules can instead surround the nanoparticles by encapsulation. In one non-limiting embodiment, sulfur-containing ligands, such as thiol-based molecules, can be utilized. Multiple embodiments of these sulfur-containing ligands are well-known in the art, and their preparation is well-described in the literature. Examples, each of which are hereby incorporated by reference in their entirety, include: M. Brust et. al., “Synthesis of thiol-derivatized gold nanoparticles in a two-phase Liquid-Liquid system,” Journal of the Chemical Society, Chemical Communications, p 801, 1994; A. C. Templeton, W. P. Wuelfing, and R. W. Murray, “Monolayer-Protected Cluster Molecules,” Accounts of Chemical Research, vol. 33, no. 1, p 27-36, 2000; M-C. Daniel and D. Astruc, “Gold nanoparticles: Assembly, Supramolecular Chemistry, Quantum-Size-Related Properties, and Applications toward Biology, Catalysis, and Nanotechnology,” Chemical Reviews, vol. 104, no. 1, p 293-346, 2004.

Sulfur-containing ligands can include, but are not limited to, a wide range of straight-chain alkanethiols (C₃-C₂₄), ω-functionalized alkanethiolates (functionalized with Br, CN, vinyl, ferrocene, phenyl, —OH, —COOH, —COOCH₃, and anthraquinone groups), thiolated polymers, p-mercaptophenol, aromatic alkanethiols, phenyl alkanethiols, mercaptoalkyl-trialkoxysilane, disulfides, xanthates, dithiols, trithiols, and tetrathiols.

While several examples of sulfur-containing ligands or thiol-based molecules are provided above, the surface protective layer is not limited to these sulfur-containing ligands or thiol-based molecules. Persons having ordinary skill in the art will recognize that a wide range of materials can suffice. For example, non sulfur-containing ligands can include, but are not limited to, citrates (e.g. trisodium citrate), phosphines, phosphine oxides, amines, carboxylates, isocyanides, quarternary ammonium salts, surfactants, and polymers.

In some embodiments, the metal-containing nanoparticles possess diameters less than about 10 nm. Particles larger than about 10 nm may exhibit weak intermolecular forces sufficient to overcome the steric repulsion provided by the surface protective layer, resulting in aggregation and precipitation of the nanoparticles out of solution. In an embodiment, the metal-containing nanoparticles possess a diameter which is less than about 9 nm. In an embodiment, the metal-containing nanoparticles possess a diameter which is less than about 8 nm. In an embodiment, the metal-containing nanoparticles possess a diameter which is less than about 7 nm. In an embodiment, the metal-containing nanoparticles possess a diameter which is less than about 6 nm. In an embodiment, the metal-containing nanoparticles possess a diameter which is less than about 5 nm. In an embodiment, the metal-containing nanoparticles possess a diameter which is less than about 4 nm. In an embodiment, the metal-containing nanoparticles possess a diameter which is less than about 3 nm. In an embodiment, the metal-containing nanoparticles possess a diameter which is less than about 2 nm. In an embodiment, the metal-containing nanoparticles possess a diameter which is less than about 1 nm. In an embodiment, the metal-containing nanoparticles possess a diameter which is less than about 0.5 nm. In an embodiment, the metal-containing nanoparticles possess a diameter which is less than about 0.1 nm.

The metal-containing compound can be present in a selected amount within the polymer composition. In an embodiment, the metal-containing nanoparticles are present in a concentration from about 0.0001 wt % to about 20 wt % on the basis of the weight of the total composition. In an embodiment, the metal-containing nanoparticles are present in a concentration greater than about 0.0001 wt % on the basis of the weight of the total composition. In an embodiment, the metal-containing nanoparticles are present in a concentration greater than about 0.001 wt % on the basis of the weight of the total composition. In an embodiment, the metal-containing nanoparticles are present in a concentration greater than about 0.01 wt % on the basis of the weight of the total composition. In an embodiment, the metal-containing nanoparticles are present in a concentration greater than about 0.1 wt % on the basis of the weight of the total composition. In an embodiment, the metal-containing nanoparticles are present in a concentration greater than about 0.5 wt % on the basis of the weight of the total composition. In an embodiment, the metal-containing nanoparticles are present in a concentration greater than about 1 wt % on the basis of the weight of the total composition. In an embodiment, the metal-containing nanoparticles are present in a concentration greater than about 2 wt % on the basis of the weight of the total composition. In an embodiment, the metal-containing nanoparticles are present in a concentration greater than about 3 wt % on the basis of the weight of the total composition. In an embodiment, the metal-containing nanoparticles are present in a concentration greater than about 4 wt % on the basis of the weight of the total composition. In an embodiment, the metal-containing nanoparticles are present in a concentration greater than about 5 wt % on the basis of the weight of the total composition. In an embodiment, the metal compound is present in an amount ranging from about 0.05 to 4 wt % on the basis of the weight of the total composition.

It has also been found that by mixing the polymer with the nanoparticles for longer periods of time results in the formation of devices which demonstrate better optical quality and photorefractive performance. Any period of time for mixing the nanoparticles with the polymer can be used to achieve a desired level of optical quality and photorefractive performance. In an embodiment, the polymer and nanoparticles are mixed for at least about 1 hour. In an embodiment, the polymer and nanoparticles are mixed for at least about 10 hours. In an embodiment, the polymer and nanoparticles are mixed for at least about 20 hours. In an embodiment, the polymer and nanoparticles are mixed for at least about 30 hours. In an embodiment, the polymer and nanoparticles are mixed for at least about 40 hours. In an embodiment, the polymer and nanoparticles are mixed for at least about 50 hours. In an embodiment, the polymer and nanoparticles are mixed for at least about 60 hours. In an embodiment, the polymer and nanoparticles are mixed for at least about 70 hours. In an embodiment, the polymer and nanoparticles are mixed for at least about 80 hours. In an embodiment, the polymer and nanoparticles are mixed for at least about 90 hours. In an embodiment, the polymer and nanoparticles are mixed for at least about 100 hours. In an embodiment, the matrix and nanoparticles are mixed for approximately 70 hours.

Many photorefractive compositions including photorefractive polymers have demonstrated poor phase stability and haziness a number of days after manufacture. Furthermore, once the compositions have shown this haziness, they generally fail to provide good photorefractive properties. The haziness of the compositions is generally attributed to incompatibilities between the components of the compositions. Generally, photorefractive compositions comprise components having charge transport ability and components having non-linear optics ability. The components having charge transport ability are usually hydro-phobic and non-polar material, while the components having non-linear optical ability are usually hydrophilic and polar. Thus, the components tend to be phase separated and give hazy compositions.

In contrast, however, embodiments of the photorefractive compositions described herein demonstrate very good phase stability and substantially no haziness even after several months. The stability is attributed to the structure of the chromophores and/or the mixture of different chromophores provided in the compositions described herein. Furthermore, as discussed below, the matrix polymer system can comprise a copolymer of components having charge transport ability and components having non-linear optical ability. So configured, the components having charge transport ability and the components having non-linear optics ability are present in one polymer chain, thus the likelihood of phase separation with the addition of further chromophores is substantially diminished.

It is further observed that the photorefractive compositions exhibited substantially no haziness, after more than several months, sometimes as much as six months. Furthermore, even after heating test samples of embodiments of the photorefractive composition between about 40 to about 120° C., typically between about 60 to about 80° C., in order to accelerate the development of phase separation, the test samples showed very good phase stability for more than a about day or a week, and sometimes more than about six months. Advantageously, this good phase stability facilitates the incorporation of the compositions of the present disclosure into optical devices for commercial products, such as holographic data storage and image recording devices.

In an embodiment, the photorefractive composition comprises a polymer matrix with at least one of a recurring unit comprising a moiety having photoconductive or charge transport ability and a recurring unit comprising a moiety having non-linear optical ability, as discussed in greater detail below. Optionally, the composition can further comprise other components, as desired, such as sensitizer and plasticizer components. One or both of the photoconductive and non-linear optical components are incorporated as functional groups into the polymer structure. In an embodiment, a photoconductive component is incorporated into the polymer structure as a side group. In an embodiment, a non-linear optical component is incorporated into the polymer structure as a side group. In an embodiment, both of the photoconductive and non-linear optical components are incorporated into the polymer structure as side groups.

In some embodiments, at least one of the charge transport and non-linear optical components is not covalently integrated into the polymer matrix. In an embodiment, the photoconductive component is a stand-alone compound. In an embodiment, the non-linear optical component is a stand-alone compound. In some embodiments, the stand-alone compound interacts with the polymer matrix by hydrogen bonding or steric interactions. In some embodiments, a polymer matrix comprising a first selected component and stand-alone compound comprising a second selected component may be mixed, as understood in the art, such that the resultant mixture provides charge transport and non-linear optical properties.

In some embodiments, the charge transport and non-linear optical components may be covalently integrated into first and second polymer matrices. The first and second polymer matrices may be the same or different. In some embodiments, the first polymer matrix comprising the first selected component and the second polymer matrix comprising the second selected component may be mixed such that the resultant mixture provides charge transport and non-linear optical properties.

The group that provides the charge transport functionality can be any group known in the art to provide such capability. If this group is to be attached to the polymer matrix as a side chain, then the group should be capable of being incorporated into a monomer that can later be polymerized to form the polymer matrix of the photorefractive composition.

Non-limiting examples of the photoconductive, or charge transport, groups are illustrated below. In an embodiment, the photoconductive groups comprise phenyl amine derivatives, such as carbazoles and di- and tri-phenyl diamines. In an embodiment, the moiety that provides the photoconductive functionality is chosen from the group of phenyl amine derivatives consisting of the following side chain Structures (i), (ii) and (iii):

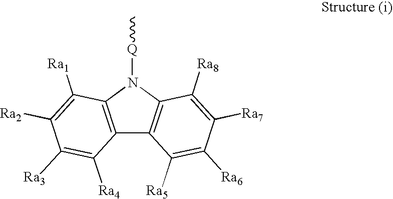

wherein Q in Structure (i) represents an alkylene group, with or without a hetero atom, such as oxygen (O), nitrogen (N), or sulfur (S); Ra₁-Ra₈ in Structure (i) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl;

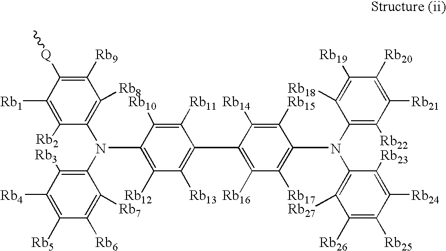

wherein Q in Structure (ii) represents an alkylene group, with or without a hetero atom; Rb₁-Rb₂₇ in Structure (ii) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl;

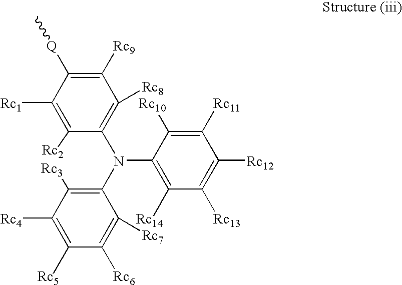

wherein Q in Structure (iii) represents an alkylene group, with or without a hetero atom, Rc₁-Rc₁₄ in Structure (iii) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

The chromophore, or group that provides the non-linear optical functionality, can be any group known in the art to provide such capability. If this group is to be attached to the polymer matrix as a side chain, then the group, or a precursor of the group, should be capable of being incorporated into a monomer that can later be polymerized to form the polymer matrix of the composition.

The chromophore of the present disclosure is represented, in one embodiment, by Structure (0):

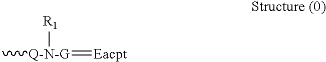

wherein Q in Structure (0) represents an alkylene group, with or without a hetero atom, such as oxygen, nitrogen, or sulfur. In some embodiments, Q is an alkylene group represented by (CH₂)ₚ, where p is an integer selected from 2 and 6. R₁ in Structure (0) is selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl. Additionally, G in Structure (0) is a group having a bridge of π-conjugated bond and Eacpt in Structure (0) is an electron acceptor group.

In this context, the term “a bridge of π-conjugated bond” refers to molecular fragments that connect two or more chemical groups by π-conjugated bond. A π-conjugated bond contains covalent bonds between atoms that have σ bonds and π bonds formed between two atoms by overlap of their atomic orbits (s+p hybrid atomic orbits for σ bonds and p atomic orbits for π bonds).

The term “electron acceptor” generally refers to an atom, ion, or molecule to which electrons are donated in the formation of a coordinate bond. Non-limiting embodiments of the electron acceptors, in order of increasing strength, can comprise:

C(O)NR²<C(O)NHR<C(O)NH₂<C(O)OR<C(O)OH<C(O)R<C(O)H<CN<S(O)₂R<NO₂

Non limiting examples of electron acceptor groups are described in U.S. Pat. No. 6,267,913, the contents of which are thereby incorporated by reference in its entirety, and shown in the following structures, include:

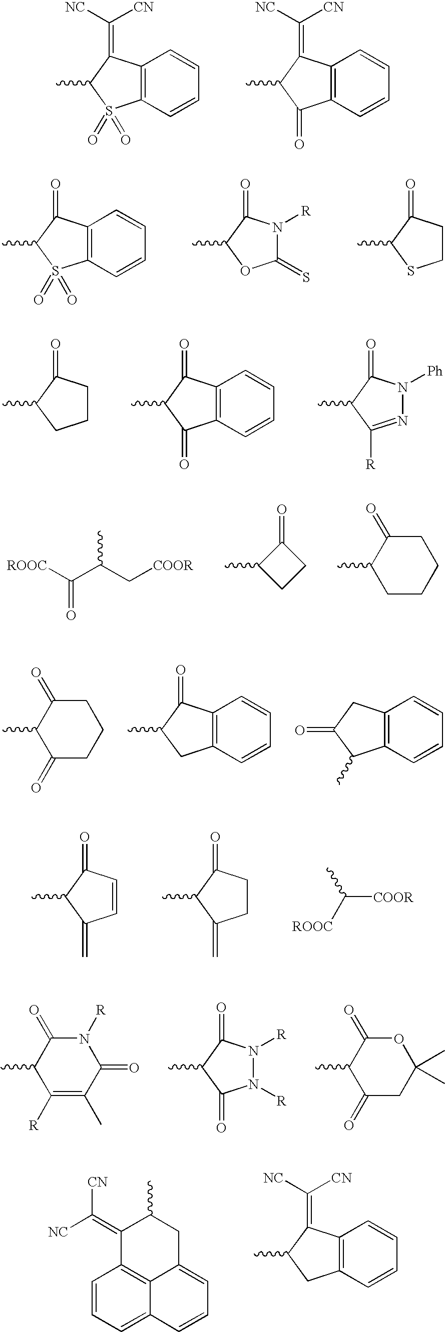

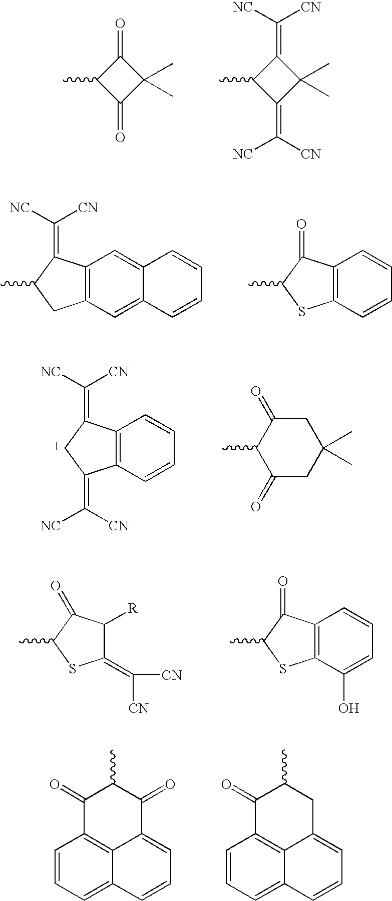

and combinations thereof.

R in each of the compounds shown above is independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, the chromophore groups are aniline-type groups or dehydronaphtyl amine groups.

In some embodiments, the moiety that provides the non-linear optical functionality is such that G in Structure (0) is represented by a structure selected from the group consisting of the Structures (iv) and (v):

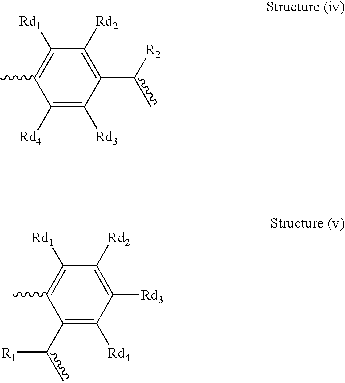

wherein Rd₁-Rd₄ and R₂ in Structures (iv) and (v) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl. In an embodiment, Rd₁-Rd₄ are each hydrogen.

Additionally, Eacpt in Structure (0) is an electron acceptor group represented by a structure selected from the group consisting of the structures:

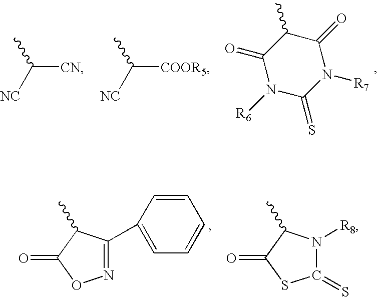

wherein R₅, R₆, R₇ and R₈ in the compounds above are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, the structure that provides the non-linear optical functionality in Structure (0) is chosen from the derivatives of the following structures:

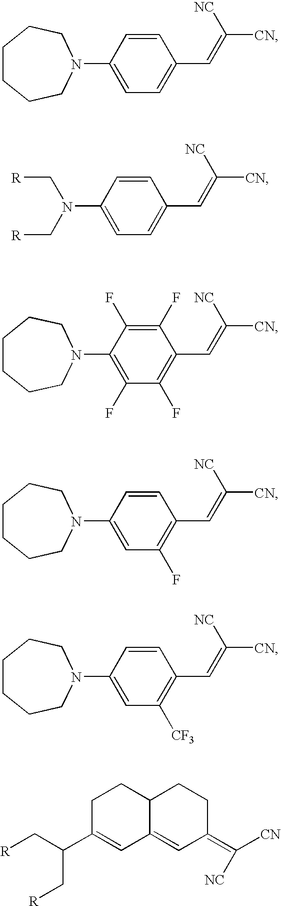

wherein R in the structures above is a group selected from the group consisting a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In an embodiment, polymer backbones, including, but not limited to, polyurethane, epoxy polymers, polystyrene, polyether, polyester, polyamide, polyimide, polysiloxane, and polyacrylate with the appropriate side chains attached, can be used to make the polymer matrices described herein. Each of the structural moieties described herein can be attached to the polymer backbones.

In an embodiment, the polymer backbone units are based on an acrylate or a styrene. Other exemplary backbone units are derived from acrylate-based monomers. Other exemplary backbone units are derived from methacrylate monomers. The first polymeric materials to include photoconductive functionality in the polymer itself were the polyvinyl carbazole materials developed at the University of Arizona. However, these polyvinyl carbazole polymers tend to become viscous and sticky when subjected to the heat-processing methods typically used to form the polymer into films or other shapes for use in photorefractive devices.

In contrast, the methacrylate-based, and more specifically acrylate-based, polymers, of the present disclosure have much better thermal and mechanical properties. That is, they provide better workability during processing by injection-molding or extrusion, for example. This is particularly true when the polymers are prepared by radical polymerization.

In an embodiment, the photorefractive polymer composition is synthesized from a monomer incorporating at least one of the above photoconductive groups and/or one of the above chromophore groups. It is recognized that a number of physical and chemical properties are also desirable in the polymer matrix. In some embodiments, the polymer comprises both a charge transport group and a chromophore group. In some such embodiments, two or more monomer units are mixed to form copolymers. Physical properties of the formed copolymer that are of importance are the molecular weight and the glass transition temperature, T_{g}. Also, it is valuable and desirable, although optional, that the composition should be capable of being formed into films, coatings, and shaped bodies of various kinds by standard polymer processing techniques, such as solvent coating, injection molding, and extrusion.

In an embodiment, the polymer comprises a weight average molecular weight, M_{w}, of about 3,000 to 500,000. In an embodiment, the polymer comprises a weight average molecular weight, M_{w} of about 5,000 to 100,000. The term “weight average molecular weight,” as used herein, means the value determined by the GPC (gel permeation chromatography) method in polystyrene standards, as is well known in the art.

In an embodiment, the polymer composition comprises a repeating unit selected from the group consisting of the Structures (i″), (ii″) and (iii″) which provides charge transport functionality:

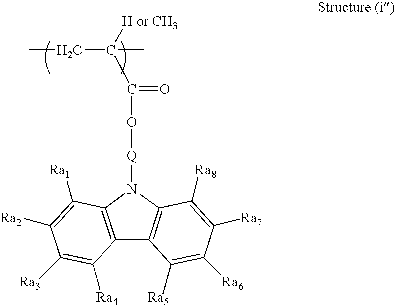

wherein Q of Structure (i′) represents an alkylene group, with or without a hetero atom; Ra₁-Ra₈ in Structure (i″) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl;

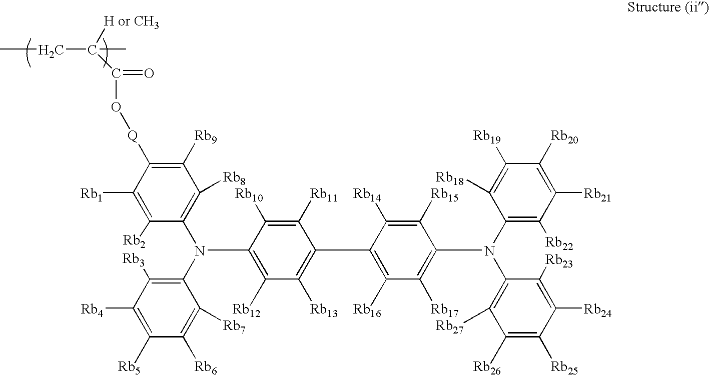

wherein Q in Structure (ii″) represents an alkylene group, with or without a hetero atom; Rb₁-Rb₂₇ in Structure (ii″) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl;

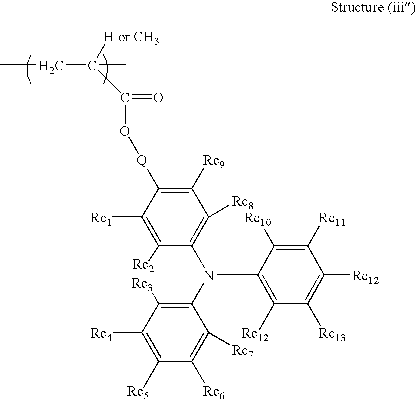

wherein Q in Structure (iii″) represents an alkylene group, with or without a hetero atom; Rc₁-Rc₁₄ in Structure (iii″) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

In some embodiments, the polymer composition comprises a repeating unit represented by the Structure (0″) which provides non-linear optical functionality:

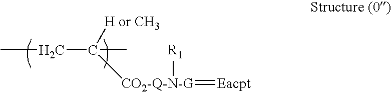

wherein Q in Structure (0″) represents an alkylene group, with or without a hetero atom, such as oxygen, nitrogen or sulfur. In some embodiment, Q is an alkylene group represented by (CH₂)ₚ where p is an integer selected from between 2 to 6. In some embodiments, Q is selected from the group consisting of ethylene, propylene, butylene, pentylene, hexylene, and heptylene. In some embodiments, R₁ in Structure (0″) is selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl. In some embodiments, R₁ in Structure (0″) is an C₁-C₆ alkyl group. In some embodiments, G in Structure (0″) is a group having a bridge of π-conjugated bond; and Eacpt in Structure (0″) is an electron acceptor group. G and Eacpt in Structure (0″) are analogous to Structure (0), which is described above.

Further non-limiting examples of recurring units including a phenyl amine derivative group as the charge transport component include carbazolylpropyl(meth)acrylate monomer; 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers to form copolymers.

Further non-limiting examples of monomers including a chromophore group as the non-linear optical component include N-ethyl, N-4-dicyanomethylidenyl acrylate and N-ethyl, N-4-dicyanomethylidenyl-3,4,5,6,10-pentahydronaphtylpentyl acrylate.

Diverse polymerization techniques are known in the art to manufacture polymers from the above discussed monomers. One such conventional technique is radical polymerization, which can be carried out by using an azo-type initiator, such as AIBN (azoisobutyl nitrile). In this radical polymerization method, the polymerization catalysis is generally used in an amount of from about 0.01 to 5 mol %, typically from about 0.1 to 1 mol %, per mole of the sum of the polymerizable monomers.

In an embodiment, conventional radical polymerization can be carried out in the presence of a solvent. Suitable solvents include, but are not limited to, ethyl acetate, tetrahydrofuran, butyl acetate, toluene, and xylene. In an embodiment, the solvent is used in an amount of about 100 to about 10000 wt % of the polymerizable monomers. In an embodiment, the solvent is used in an amount of about 1000 to about 5000 wt % of the polymerizable monomers.

In another embodiment, conventional radical polymerization is carried out without a solvent in the presence of an inactive gas. In an embodiment, the inactive gas comprises one of nitrogen, argon, and helium. In an embodiment, the gas pressure during polymerization in the presence of an inactive gas is about 1 to about 50 atm. In an embodiment, the gas pressure during polymerization in the presence of an inactive gas is about 1 to about 5 atm.

The conventional radical polymerization can be carried out at a temperature of about 50° C. to about 100° C. The radical polymerization can occur for about 1 hour to about 100 hours, depending on the desired final molecular weight and polymerization temperature, and taking into account the rate of polymerization.

By carrying out the radical polymerization technique based on the teachings provided herein, it is possible to prepare polymers having charge transport groups, polymers having non-linear optical groups, and random or block copolymers carrying both charge transport and non-linear optical groups. Polymer systems can further be prepared from combinations of these polymers. Additionally, by following the techniques described herein, it is possible to prepare such materials with exceptionally good properties, such as photoconductivity, response time, and diffraction efficiency as discussed below in the Examples.

In some embodiments, the polymer comprises a recurring unit that includes a moiety selected from the group consisting of the carbazole moiety, tetraphenyl diaminobiphenyl moiety, and triphenylamine moiety. So configured, the embodiments of the photorefractive compositions described herein exhibit improved photorefractive behavior over similar compositions which do not contain the nanoparticles described herein, such as gold nanoparticles.

Where the polymer is made from monomers that provide only charge transport ability, the photorefractive compositions described herein can be made by dispersing a component that possesses non-linear optical properties through the polymer matrix, as is described in U.S. Pat. No. 5,064,264 to IBM, the contents of which are hereby incorporated by reference in their entirety. Suitable materials are known in the art and are described in the literature, such as D. S. Chemla & J. Zyss, “Nonlinear Optical Properties of Organic Molecules and Crystals” (Academic Press, 1987), the contents of which are hereby incorporated by reference in their entirety. Also, as described in U.S. Pat. No. 6,090,332 to Seth R. Marder et. al., the contents of which are hereby incorporated by reference in their entirety, fused ring bridge, ring locked chromophores that form thermally stable photorefractive compositions can be used. Non-limiting examples of chromophore additives include, but are not limited to, the following chemical structures:

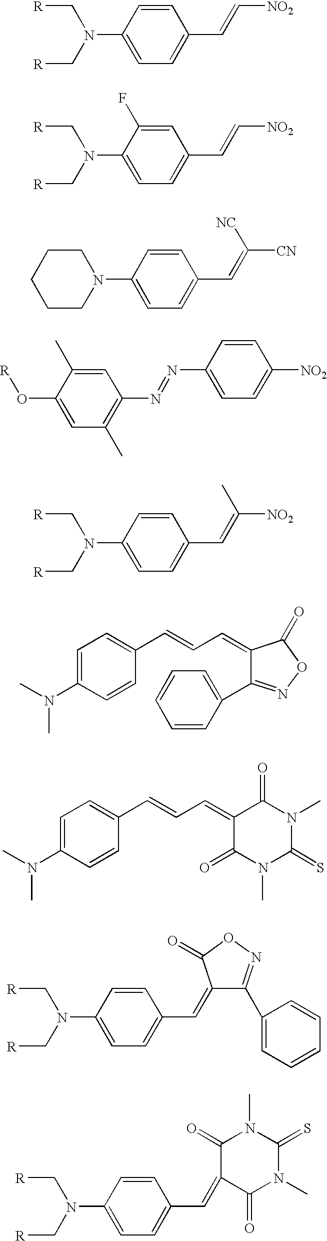

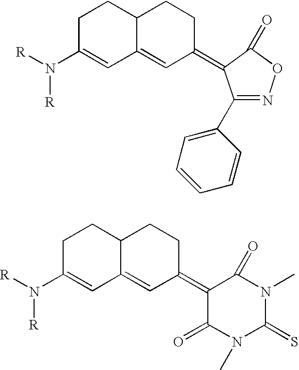

In an embodiment, the chosen chromophore compound or compounds can be mixed in the matrix copolymer in a concentration of greater than about 1 wt % based on the weight of the composition. In an embodiment, the chosen chromophore compound or compounds can be mixed in the matrix copolymer in a concentration of greater than about 10 wt % based on the weight of the composition. In an embodiment, the chosen chromophore compound or compounds can be mixed in the matrix copolymer in a concentration of greater than about 20 wt % based on the weight of the composition. In an embodiment, the chosen chromophore compound or compounds can be mixed in the matrix copolymer in a concentration of greater than about 30 wt % based on the weight of the composition. In an embodiment, the chosen chromophore compound or compounds can be mixed in the matrix copolymer in a concentration of greater than about 40 wt % based on the weight of the composition. In an embodiment, the chosen chromophore compound or compounds can be mixed in the matrix copolymer in a concentration of greater than about 50 wt % based on the weight of the composition. In an embodiment, the chosen chromophore compound or compounds can be mixed in the matrix copolymer in a concentration of greater than about 60 wt % based on the weight of the composition. In an embodiment, the chosen chromophore compound or compounds is present at a weight of about 30 wt % based on the weight of the composition.

On the other hand, if the polymer is made from monomers that provide only the non-linear optical ability, the photorefractive composition can be made by mixing a component that possesses charge transport properties into the polymer matrix, as is described in U.S. Pat. No. 5,064,264 to IBM, the contents of which are hereby incorporated by reference. Typical charge transport compounds are good hole transfer compounds, for example, N-alkyl carbazole or triphenylamine derivatives.

As an alternative, or in addition to, adding the charge transport component in the form of a dispersion of entities comprising individual molecules with charge transport capability, a polymer blend can be made of individual polymers with charge transport and non-linear optical abilities. For the charge transport polymer, the polymers already described above, such as those containing phenyl-amine derivative side chains, can be used. Since polymers containing only charge transport groups are comparatively easy to prepare by conventional techniques, the charge transport polymer can be made by radical polymerization or by any other convenient method.

To prepare the non-linear optical containing copolymer itself, monomers that have side-chain groups possessing non-linear-optical ability can be used. Non-limiting examples of monomers that can be used are those containing the following chemical structures:

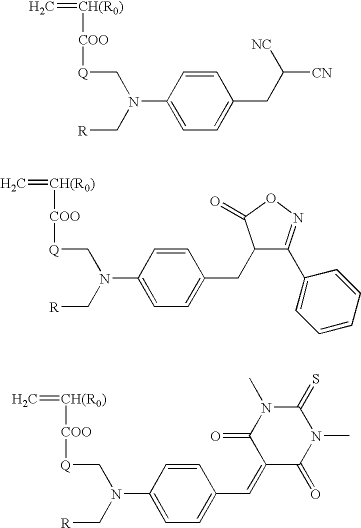

wherein each Q in the compounds above independently represents an alkylene group with or without a hetero atom, such as oxygen, nitrogen, or sulfur. In some embodiments, Q in the compounds above is an alkylene group represented by (CH₂)ₚ where p is an integer selected from 2 to 6. R₀ in each of the compounds above is independently a hydrogen atom or methyl group. R in each of the compounds above is independently a C₁-C₁₀ linear alkyl group or C₁-C₁₀ branched alkyl group. In some embodiments, R in the compounds above is an alkyl group which is selected from methyl, ethyl, or propyl.

A new technique for preparing the copolymers has also been discovered. The technique involves the use of a precursor monomer containing a precursor functional group for non-linear optical ability. Typically, this precursor is represented by the following general structure:

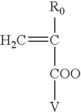

wherein R₀ in the compound above is a hydrogen atom or methyl group, and V in the compound above is selected from the group consisting of the following structures (1) and (2):

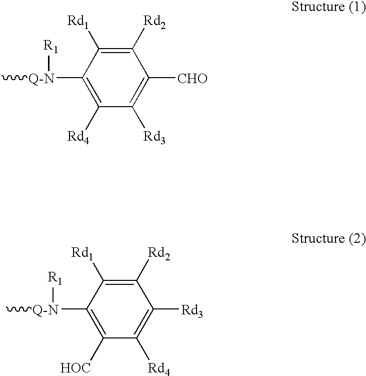

In both Structures (1) and (2), Q represents an alkylene group, with or without a hetero atom, such as oxygen, nitrogen, or sulfur. In some embodiments, Q in Structures (1) and (2) is an alkylene group represented by (CH₂)ₚ where p is an integer selected from between 2 to 6. In an embodiment, Rd₁-Rd₄ in Structures (1) and (2) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl. In an embodiment, R₁ in Structures (1) and (2) represents a linear or branched alkyl group with up to 10 carbons. In an embodiment, R₁ in Structures (1) and (2) is an alkyl group selected from methyl, ethyl, propyl, butyl, pentyl, and hexyl.

To prepare copolymers, both the non-linear optical monomer and the charge transport monomer, each of which can be selected from the types mentioned above, can be used. The procedure for performing the radical polymerization in this case involves the use of the same polymerization methods and operating conditions, according to the teachings provided above.

After the precursor copolymer has been formed, it can be converted into the corresponding copolymer having non-linear optical groups and capabilities by a condensation reaction. In some embodiments, the condensation reagent can be selected from the group consisting of:

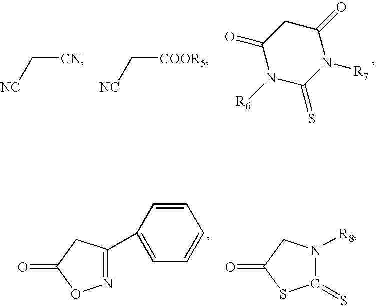

wherein R₅, R₆, R₇ and R₈ in the compounds above are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

The condensation reaction can be performed at room temperature for about 1 to about 100 hours, in the presence of a pyridine derivative catalyst. A solvent, such as butyl acetate, chloroform, dichloromethylene, toluene or xylene can also be used. Optionally, the reaction can be carried out without the catalyst at a solvent reflux temperature of about 30° C. or above for about 1 to 100 hours.

There are no restrictions on the ratio of monomer units for the copolymers comprising a repeating unit including the first moiety having charge transport ability, a repeating unit including the second moiety having non-linear-optical ability, and, optionally, a repeating unit including the third moiety having plasticizing ability. In an embodiment, the ratio per 100 weight parts of a (meth)acrylic monomer having charge transport ability to a (meth)acrylate monomer having non-linear optical ability is a range between about 1 and 200 weight parts. In an embodiment, the ratio per 100 weight parts of a (meth)acrylic monomer having charge transport ability to a (meth)acrylate monomer having non-linear optical ability is a range between about 10 and 100 weight parts. If this ratio is less than about 1 weight part, the charge transport ability of copolymer itself is weak and the response time tends to be too slow to give good photorefractivity. However, even in this case, the addition of already described low molecular weight components having non-linear-optical ability can enhance photorefractivity. On the other hand, if this ratio is more than about 200 weight parts, the non-linear-optical ability of copolymer itself is weak, and the diffraction efficiency tends to be too low to give good photorefractivity. Even in this case, though, the addition of already described low molecular weight components having charge transport ability can enhance photorefractivity.

In some embodiments, a component that possesses plasticizer properties can be mixed into the polymer matrix. As preferred plasticizer compounds, any commercial plasticizer compound can be used, such as phthalate derivatives or low molecular weight hole transfer compounds, for example N-alkyl carbazole or triphenylamine derivatives or acetyl carbazole or triphenylamine derivatives. Structure (3) presents one example of the plasticizer which is an N-alkyl carbazole containing electron acceptor group.

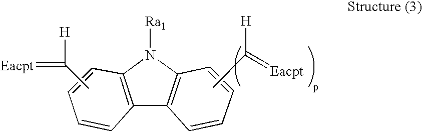

wherein Ra₁ in Structure (3) is independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

The plasticizer can help to enhance the stability of the photorefractive composition, since the plasticizer contains both a N-alkyl carbazole or triphenylamine moiety and a non-linear optics moiety in one compound. Further non-limiting examples of the plasticizer include ethyl carbazole; 4-(N,N-diphenylamino)-phenylpropyl acatate; 4-(N,N-diphenylamino)-phenylmethyloxy acatate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more monomers.

Un-polymerized monomers can be used as low molecular weight hole transfer compounds. Non limiting examples include for example 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Optionally, other components can be added to the polymer matrix in order to provide or improve the desired physical properties discussed above. In an embodiment, a photosensitizer is added to serve as a charge generator in order to provide good photorefractive capability. Non-limiting examples of photosensitizers that can be used include 2,4,7-trinitro-9-fluorenone dicyanomalonate (TNFDM), dinitro-fluorenone, mononitro-fluorenone, and C₆₀. Various other types of photosensitizers are known in the art and can also be used. The amount of photosensitizer required is usually less than about 3 wt %.

Employing embodiments described herein, photorefractive films can be provided. Film thickness can vary over a wide range. In general, if the film thickness is less than about 10 μm, diffracted signals falls substantially outside the desired Bragg Refraction region, instead within the Raman-Nathan Region, which fails to provide proper grating behavior. On the other hand, if the sample thickness is greater than about 200 μm, biased voltages considered too large would be required to show grating behavior. Furthermore, the film composition transmittance for green laser beam can be reduced significantly, resulting in substantially no grating signals. In an embodiment, the film has a thickness of about 10 μm to about 200 μm. In an embodiment, the film has a thickness of about 200 μm. In an embodiment, the film has a thickness of about 180 μm. In an embodiment, the film has a thickness of about 160 μm. In an embodiment, the film has a thickness of about 140 μm. In an embodiment, the film has a thickness of about 120 μm. In an embodiment, the film has a thickness of about 100 μm. In an embodiment, the film has a thickness of about 80 μm. In an embodiment, the film has a thickness of about 60 μm. In an embodiment, the film has a thickness of about 50 μm. In an embodiment, the film has a thickness of about 40 μm. In an embodiment, the film has a thickness of about 30 μm. In an embodiment, the film has a thickness of about 20 μm. In an embodiment, the film has a thickness of about 10 μm. In an embodiment, the film thickness is from about 30 μm to about 150 μm.

One advantageous feature of the embodiments of the photorefractive composition is the fast response and decay time. Response time (rising time) is the time needed to build up the diffraction grating in the photorefractive material when exposed to a laser writing beam, while decay time (erasing time) is the time needed to erase the diffraction grating in the photorefractive material when blocked to a laser writing beam.

For example, in a first photorefractive composition employing a copolymer comprising TPD acrylate and chromophore in a ratio of about 10:1, respectively, and nanoparticle content ranging from about 0 to about 0.25 mg, rising times, decay times, and photorefractive efficiencies are found to improve in comparison to comparable compositions without the gold nanoparticles. For example, as discussed in greater detail below, the rising time was measured to be low. In an embodiment, the rising time is 16 ms or less. In an embodiment, the rising time is 12 ms or less. In an embodiment, the rising time is 8 ms or less. In an embodiment, the rising time is 5.6 ms or less.

The rising time can also be measured using percentage terms. In an embodiment, the rising time is improved by (e.g., reduced by) approximately 37% or more as compared to the comparable composition without nanoparticles. In an embodiment, the rising time is improved by (e.g., reduced by) approximately 40% or more as compared to the comparable composition without nanoparticles. In an embodiment, the rising time is improved by (e.g., reduced by) approximately 45% or more as compared to the comparable composition without nanoparticles. In an embodiment, the rising time is improved by (e.g., reduced by) approximately 50% or more as compared to the comparable composition without nanoparticles. In an embodiment, the rising time is improved by (e.g., reduced by) approximately 55% or more as compared to the comparable composition without nanoparticles. In an embodiment, the rising time is improved by (e.g., reduced by) approximately 60% or more as compared to the comparable composition without nanoparticles. In an embodiment, the rising time is improved by (e.g., reduced by) approximately 65% or more as compared to the comparable composition without nanoparticles.

The decay time was measured to be low. In an embodiment, the decay time is approximately 8.5 ms or less. In an embodiment, the decay time is approximately 6 ms or less. In an embodiment, the decay time is approximately 4.5 ms or less. In an embodiment, the decay time is approximately 4.1 ms or less. In percentage terms, the decay time is improved by (e.g., reduced by) 13.7% or more, 20% or more, 30% or more, 40% or more, 50% or more and 53% or more less than the comparable composition without nanoparticles. The diffraction efficiency was improved by (e.g., reduced by) approximately 50% or more, 60% or more, 70% or more, 80% or more, 90% or more, and approximately 100%.

In certain embodiments, for example, the measured values of rising time and decay time were improved by (e.g., reduced by) about 5.6 ms and 4.1 ms, respectively, which are among the fastest PR materials reported.

In a second photorefractive composition usirig a polymer comprising a copolymer of TPD acrylate, CbZ acrylate, and chromophore in a ratio of about 5:5:1, respectively, and nanoparticle content ranging from about 0 to about 0.25 mg, rising and embodiments, such optical devices may be used by applying an electric field to a photorefractive composition. For example, laser beams may be used to irradiate at least a portion of the device comprising the photorefractive composition. The optical properties of the photorefractive compositions described herein, such as rising time, decay time, and diffraction efficiency, may be preserved and exhibited by the optical devices. In further alternative embodiments, such devices may comprise optical devices for performing functions such as high-density optical data storage, dynamic holography, optical image processing, phase conjugated mirrors, optical computing, parallel optical logic, and pattern recognition. Such devices may comprise, in certain embodiments, holographic data storage and image recording devices.

The embodiments of the present disclosure are now further described by the following non-limiting examples, which are intended to be illustrate various aspects of manufacture and resultant properties of the embodiments of the present disclosure but are not intended to limit the scope or underlying principles in any way. One skilled in the art will readily recognize that additional embodiments consistent with the teachings above also are contemplated herein.

### EXAMPLES

### (a) Monomers Containing Charge Transport Groups

TPD acrylate type charge transport monomers (N-[acroyloxypropylphenyl]-N,N′,N′-triphenyl-(1,1′-biphenyl)-4,4′-diamine) (TPD acrylate) were purchased from Fuji Chemical, Japan. The TPD acrylate type monomer possessed the structure:

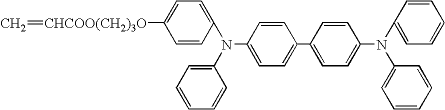

decay times are also found to be improved over comparable compositions without nanoparticles. The rising times are found to be approximately 72.6 ms or less, 65 ms or less, 60 ms or less, 55 ms or less, 50 ms or less, and 46 ms or less. In percentage terms, the decay times are improved by (e.g., reduced by) approximately 10.5% or more, 15% or more, 20% or more, 25% or more, 30% or more, 35% or more, 40% or more, and 43% or more less than the comparable composition without nanoparticles. The decay times are found to be approximately 38 ms or less, 35ms or less, 30ms or less, 25 ms or less, and 21.4 ms or less. In percentage terms, the decay times are 5% or more, 10% or more, 20% or more, 30% or more, 40% or more, and 45% or more less than the comparable composition without nanoparticles.

Such response times may as those described above may be achieved without resorting to a very high electric field, in excess of about 100V/μm, as expressed as biased voltage. For example, these fast response times can generally be achieved at biased voltages no higher than about 90 V/μm and no higher than about 80V/μm.

Another advantageous feature of the embodiments of the photorefractive compositions of the present disclosure is the diffraction efficiency, η. Diffraction efficiency is defined as the ratio of the intensity of a diffracted beam to the intensity of an incident probe beam, and is determined by measuring the intensities of the respective beams. The closer η is to 1 (or 100% in percentage terms), the more efficient is the device. In embodiments of the present compositions, measured diffraction efficiencies range from about 43% without nanoparticles to about 100% with 0.25 mg of nanoparticles.

Methods for measuring response and decay times, as well as diffraction efficiency are generally understood in the art. In certain embodiments, response and decay times of a sample of material may be measured by transient four-wave mixing (TFWM) experiments, while the diffraction efficiency may be measured using four wave mixing experiments, as detailed in the Examples section below. Beneficially, these results are achieved without resorting to high electric fields, as expressed as biased voltages.

Optical devices may also be fabricated using photorefractive compositions of the present disclosure. Such devices may comprise, in certain embodiments, an optical substrate upon which a layer of the photorefractive composition is deposited. In certain

### (b) Monomers Containing Non-Linear Optical Groups

The non-linear-optical precursor monomer 5-[N-ethyl-N-4-formylphenyl]amino-pentyl acrylate was synthesized according to the following synthesis scheme:

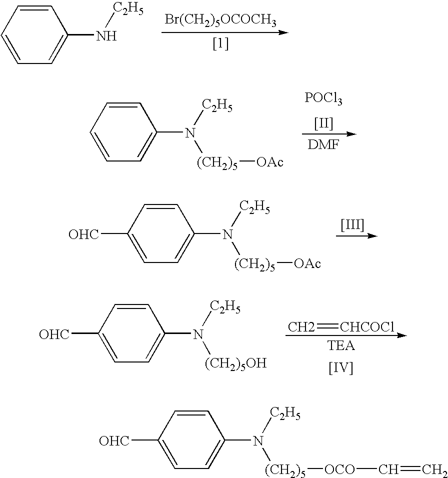

### Step I:

Bromopentyl acetate (about 5 mL or 30 mmol), toluene (about 25 mL), triethylamine (about 4.2 mL or 30 mmol), and N-ethylaniline (about 4 mL or 30 mmol) were intermixed together at room temperature. This solution was heated at about 120° C. overnight. After cooling down, the reaction mixture was rotary-evaporated. The residue was purified by silica gel chromatography (developing solvent: hexane/acetone=about 9/1). An oily amine compound was obtained with a yield of about 6.0 g or 80%.

### Step II:

Anhydrous DMF (about 6 mL or 77.5 mmol) was cooled in an ice-bath. Then, POCl₃ (about 2.3 mL or 24.5 mmol) was added dropwise into an approximately 25 mL flask, and the mixture was allowed to warm to about room temperature. The resulting amine compound (about 5.8 g or 23.3 mmol) resulting from Step I was added through a rubber septum by syringe with dichloroethane. After stirring for about 30 min, this reaction mixture was heated to about 90° C. and the reaction was allowed to proceed overnight under an argon atmosphere. The next day, the reaction mixture was cooled, and poured into brine water and extracted by ether. The ether layer was washed with a potassium carbonate solution and dried over anhydrous magnesium sulfate. After removing the magnesium sulfate, the solvent was removed and the residue was purified by silica gel chromatography using a developing solvent having a hexane/ethyl acetate ratio of about 3/1. An aldehyde compound was obtained with a yield of about 4.2 g or 65%.

### Step III:

The aldehyde compound (about 3.92 g, or 14.1 mmol) resulting from Step II was dissolved with methanol (about 20 mL). Into this mixture, potassium carbonate (about 400 mg) and water (about 1 mL) were added at room temperature and the solution was stirred overnight. The next day, the solution was poured into brine water and extracted by ether. The ether layer was dried over anhydrous magnesium sulfate. After removing the magnesium sulfate, the solvent was removed and the residue was purified by silica gel chromatography using a developing solvent comprising a hexane/acetone in a ratio of approximately 1/1. An aldehyde alcohol compound was obtained with a yield of about 3.2 g or 96%.

### Step IV:

The aldehyde alcohol (about 5.8 g or 24.7 mmol) resulting from Step III was dissolved with anhydrous THF (about 60 mL). Into this mixture, triethylamine (about 3.8 mL or 27.1 mmol) was added and the solution was cooled by ice-bath. Acrolyl chloride (about 2.1 mL or 26.5 mmol) was added and the solution was maintained at about 0° C. for about 20 minutes. Thereafter, the solution was allowed to warm up to approximately room temperature and stirred at room temperature for about 1 hour, at which point TLC indicated that substantially all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography using a developing solvent comprising hexane/acetone in a ratio of approximately 1/1. The compound yield was about 5.38 g or 76%, and the compound purity was approximately 99%, as determined by GC.

### (c) Synthesis of Non-Linear-Optical Chromophore 7-FDCST

The non-linear-optical precursor 7-FDCST (7 member ring dicyanostyrene, 4-homopiperidino-2-fluorobenzylidene malononitrile) was synthesized according to the following two-step synthesis scheme:

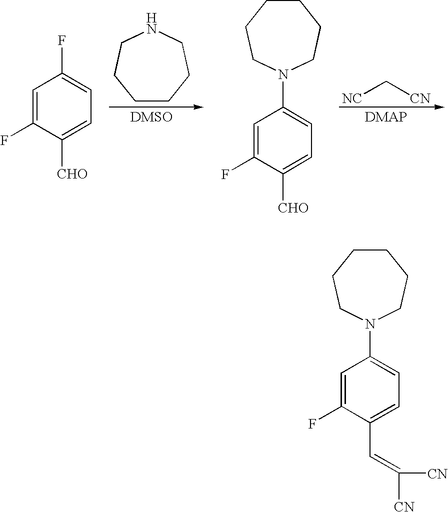

A mixture of 2,4-difluorobenzaldehyde (about 25 g or 176 mmol), homopiperidine (about 17.4 g or 176 mmol), lithium carbonate (about 65 g or 880 mmol), and DMSO (about 625 mL) was stirred at about 50° C. for about 16 hr. Water (about 50 mL) was added to the reaction mixture. The products were then extracted with ether (about 100 mL). After removal of the ether, the crude products were purified by silica gel column chromatography using hexanes-ethyl acetate in a ratio of about 9:1 as eluent and crude intermediate was obtained (about 22.6 g,). 4-(Dimethylamino)pyridine (about 230 mg) was added to a solution of the 4-homopiperidino-2-fluorobenzaldehyde (about 22.6 g or 102 mmol) and malononitrile (about 10.1 g or 153 mmol) in methanol (about 323 mL). The reaction mixture was kept at about room temperature and the product was collected by filtration and purified by recrystallization from ethanol with a yield of about 18.1 g or 38%.

### (d) Polymer Materials

### Production Example 1

### Preparation of Copolymer by AIBN Radical Initiated Polymerization (TPD Acrylate/Chromophore Type 10:1)

The charge transport monomer N-[(meth)acroyloxypropylphenyl]-N,N′,N′-triphenyl-(1,1′-biphenyl)-4,4′-diamine (TPD acrylate) (about 43.34 g) and the non-linear-optical precursor monomer 5-[N-ethyl-N-4-formylphenyl]amino-pentyl acrylate (about 4.35 g), prepared as described above, were placed into a three-necked flask. After toluene (about 400 mL) was added and purged by argon gas for about 1 hour, azoisobutylnitrile (about 118 mg) was added to the solution. The solution was then heated to about 65° C., while continuing to purge with argon gas.

After about 18 hrs of polymerization, the polymer solution was diluted with toluene. The polymer was precipitated from the solution and added to methanol. The resulting polymer precipitate was collected and washed in diethyl ether and methanol. The white polymer powder was then collected and dried. The yield of polymer was about 66%.

The weight average and number average molecular weights were measured by gel permeation chromatography, using a polystyrene standard. The measurements determined a number average molecular weight (Mₙ) of about 10,600 and a weight average molecular weight (M_{w}) of about 17,100, giving a polydispersity of about 1.61.

To form the polymer with non-linear-optical capability, the precipitated precursor polymer (about 5.0 g) was dissolved with chloroform (about 24 mL). Into this solution, dicyanomalonate (about 1.0 g) and dimethylaminopyridine (about 40 mg) were added, and the reaction was allowed to proceed overnight at 40° C. As before, the polymer was recovered from the solution by filtration of impurities, followed by precipitation into methanol, washing and drying.

### Production Example 2

### Preparation of Copolymer by AIBN Radical Initiated Polymerization (TPD Acrylate/CBZ Acrylate/Chromophore Type 5:5:1)

The charge transport monomer N-[(meth)acroyloxypropylphenyl]-N,N′,N′-triphenyl-(1,1′-biphenyl)-4,4′-diamine (TPD acrylate) (about 5.0 g), N-[(meth)acroyloxypropylphenyl]-N,N′-diphenylamine (CBZ acrylate) (about 5.0 g), and the non-linear-optical precursor monomer 5-[N-ethyl-N-4-formylphenyl]amino-pentyl acrylate (about 1.0 g), prepared as described above were put into a three-necked flask. After toluene (about 85 mL) was added and purged by argon gas for about 1 hour, azoisobutylnitrile (about 47 mg) was added into this solution. Then, the solution was heated to about 65° C., while continuing to purge with argon gas.

After about 18 hrs of polymerization, the polymer solution was diluted with toluene. The polymer was precipitated from the solution and added to methanol, and then the resulting polymer precipitate was collected and washed in diethyl ether and methanol. The white polymer powder was collected and dried. The yield of polymer was about 84%.

The weight average and number average molecular weights were measured by gel permeation chromatography, using polystyrene standard. The results were Mn of about 12,300 and Mw of about 27,700, giving a polydispersity of about 2.25.

To form the polymer with non-linear-optical capability, the precipitated precursor polymer (about 5.0 g) was dissolved with chloroform (2 about 4 mL). Into this solution, dicyanomalonate (about 1.0 g) and dimethylaminopyridine (about 40 mg) were added, and the reaction was allowed to proceed overnight at about 40° C. As before, the polymer was recovered from the solution by filtration of impurities, followed by precipitation into methanol, washing and drying.

### (e) Synthesis of Gold Nanoparticles (C12-MPC-Au)

Dodecane-1-thiol capped gold clusters were prepared by a modification of Murray's procedure (Hostetler, M. J.; Stokes, J. J.; Murray, R. W., Langmuir 1996, 12, 3604). A molar ratio of thiol:HAuCl₄.3H₂O:tetra-octylammonium bromide:NaBH₄ of about 2:1:2.5:10 produced a capped gold cluster of about 2.2 nm diameter (Gu, T.; Whitesell, J. K.; Fox, M. A. Chem. Mater 2003, 15, 1358). To a vigorously stirred solution of about 350 mg of tetra-octylammonium bromide (about 2.5 equiv) in about 12 mL of toluene was added about 100 mg of HAuCl₄.3H₂O (about 1 equiv) in about 4 mL of de-ionized water. The yellow HAuCl₄.3H₂O aqueous solution quickly cleared and the toluene phase became orange-red as the AuCl₄⁻ was phase-transferred. The organic phase was isolated, the desired amount of alkane-1-thiol was added, and the resulting solution was stirred for about 20 min at room temperature. Sodium borohydride (about 96 mg or 10 equiv) in about 3 mL of deionized water was added in one aliquot. The very dark organic phase was further stirred at room temperature overnight. The organic phase was collected and the solvent was removed by rotary evaporation. The black product was suspended in about 50 mL of ethanol, collected on a glass filtration frit, and washed with copious amounts of ethanol and acetone.

### Example 1

### Preparation of Photorefractive Composition

A photorefractive composition testing sample was prepared. The components of the composition were provided in approximate amounts as follows:

| | |
|---|---|
| (i) Matrix polymer (described in Production Example 1): | 49.88 wt % |
| (ii) Prepared chromophore of 7FDCST | 29.92 wt % |
| (iii) Ethyl carbazole plasticizer | 19.95 wt % |
| (iv) Gold nanoparticles | 0.25 wt % |

To prepare the composition, the components listed above were dissolved with toluene and stirred overnight at room temperature. After removing the solvent by rotary evaporator and vacuum pump, the residue was scratched and gathered. To make testing samples, this powdery residue mixture was put on a slide glass and melted at about 125° C. to make a film, or pre-cake, having a thickness of about 200-300 μm. Small portions of this pre-cake were taken off and sandwiched between indium tin oxide (ITO) coated glass plates separated by a roughly 30 μm spacer to form the individual samples.

### Measurement 1—Diffraction Efficiency

The diffraction efficiency of photorefractive compositions was measured at about 532 nm by four-wave mixing experiments. Steady-state and transient four-wave mixing experiments were performed using two writing beams making an angle of about 20.5 degree in air; with the bisector of the writing beams making an angle of about 60 degrees relative to the sample normal.

For the four-wave mixing experiments, two s-polarized writing beams with equal intensity of about 0.2 W/cm² in the sample were used; the spot diameter was about 600 μm. A p-polarized beam of about 1.7 mW/cm² counter propagating with respect to the writing beam nearest to the surface normal was used to probe the diffraction gratings; the spot diameter of the probe beam in the sample was about 500 μm. The diffracted and the transmitted probe beam intensities were monitored to determine the diffraction efficiency. Then, this diffraction efficiency was designated as η.

### Measurement 2—Rising Time (Response Time)

As illustrated below, a particularly advantageous feature of the photorefractive compositions of the present disclosure is the fast response time they exhibit. Response time (rising time) is the time needed to build up the diffraction grating in the photorefractive material when exposed to a laser writing beam. Response time is important because a faster response time provides faster grating build-up and enables the photorefractive composition to be used for wider applications, such as real-time hologram applications.

In order to measure the response time, the diffraction efficiency was measured as a function of the applied field, using a procedure similar to that described in Measurement 1 above by four-wave mixing experiments at about 532 nm with s-polarized writing beams and a p-polarized probe beam. The angle between the bisector of the two writing beams and the sample normal was about 60 degrees and the angle between the writing beams was adjusted to provide a roughly 2.5 μm grating spacing in the material (about 20 degrees). The writing beams had substantially equal optical powers of about 0.45 mW/cm², leading to a total optical power of about 1.5 mW on the photorefractive composition, after correction for reflection losses. The beams were collimated to a spot size of approximately about 500 μm. The optical power of the probe was about 100 μW.

The measurement of the grating buildup time was performed as follows. A selected electric field (V/μm) was applied to the sample and the sample was illuminated with two writing beams and the probe beam for about 100 ms. The evolution of the diffracted beam was subsequently recorded. The response time (rising time) was estimated as the time required to reach about e⁻¹ of steady-state diffraction efficiency. To quantify this time, the measured data were fit to the function:

η(t)=sin² {(η₀(1−a₁e^{-t/J}₁−a₂e^{-t/J}₂)}

where a₁+a₂=1, η(t) is the diffraction efficiency at time t, η₀ is the steady-state diffraction efficiency, and J₁ and J₂ are the grating build-up times. The smaller number of J₁ and J₂ was taken as the response time (rising time).

### Measurement 3—Decay Time (Erasing Time)

Decay time (erasing time) is the time needed to erase the diffraction grating in the photorefractive material when blocked to a laser writing beam. In order to measure the decay time, the diffraction efficiency was measured as a function of the applied field, using a procedure similar to that described in Measurement 1 above by four-wave mixing experiments at about 532 nm with s-polarized writing beams and a p-polarized probe beam. The angle between the bisector of the two writing beams and the sample normal was about 60 degrees and the angle between the writing beams was adjusted to provide a roughly 2.5 μm grating spacing in the material (about 20 degrees). The writing beams had substantially equal optical powers of about 0.45 mW/cm², leading to a total optical power of about 1.5 mW on the polymer, after correction for reflection losses. The beams were collimated to a spot size of approximately 500 μm. The optical power of the probe was about 100 μW.

The measurement of the grating erasing time was done as follows. A selected electric field (V/μm) was applied to the sample and the sample was exposed to both two writing beams until the diffraction efficiency reach the steady state. Subsequently, one of the writing beams was blocked and the evolution of the diffracted beam was recorded. The decay time (erasing time) was estimated as the time required to erase about e⁻¹ of steady-state diffraction efficiency. To quantify this time, the measured data were fit to the function:

η(t)=1−sin² {η₀(1−b₁e^{-t/L1}−b₂e^{-t/L2})}

where b₁+b₂=1, η(t) is the diffraction efficiency at time t, η₀ is the steady-state diffraction efficiency, and L₁ and L₂ are the grating erasing times. The smaller number of L₁ and L₂ was taken as the decay time (erasing time).

### Example 2

A photorefractive composition was obtained in the same manner as in the Example 1 except that gold nanoparticle weight percentage was decreased to the ratio as set forth in Table 1.

The compositions in Examples 1 and 2 were then compared to a comparative composition that did not contain nanoparticles.

TABLE 1
Photorefractive compositions using the matrix polymer of production example 1

| | Matrix | | | | | | |
|---|---|---|---|---|---|---|---|
| | polymer | | | | | | |
| | (mg) | | | Gold | Diffraction | Rising | Decay |
| | (Production | FDCST | ECZ | nanoparticle | efficiency | time | time |
| Example | example 1) | (mg) | (mg) | (mg) | at 100 V/um | (ms) | (ms) |
| 1 | 50 | 30 | 20 | 0.25 | 100% | 5.6 | 4.1 |
| 2 | 50 | 30 | 20 | 0.1 | 62% | 10.4 | 7.6 |
| Comparative | 50 | 30 | 20 | 0 | 43% | 16.4 | 8.8 |
| Example 1 | | | | | | | |

As shown in Table 1, the photorefractive composition having a range of gold particle concentrations show improved rising times, decay times, and diffraction efficiencies over the comparative example. As shown in this comparative data which is described in prior art, in a photorefractive composition with about 0.25% gold nanoparticles, the diffraction peak was shifted to using a lower bias voltage.

The rising time was measured to be approximately 16 ms or less, 12 ms or less, 8 ms or less, and 5.6 ms or less. In percentage terms, the rising time is measured to be less than the comparative example by approximately 37% or more, 40% or more, 45% or more, 50% or more, 55% or more, 60% or more, and 65% or more. The decay time was measured to be approximately 8.5 ms or less, 6 ms or less, 4.5 ms or less, and 4.1 ms or less. In percentage terms, the decay time is measured to less than the comparative example by 13.7% or more, 20% or more, 30% or more, 40% or more, 50% or more and 53% or more. The diffraction efficiency was measured to be approximately 50% or more, 60% or more, 70% or more, 80% or more, 90% or more, and approximately 100% than the comparative example.

In certain embodiments, for example, the measured values of rising time and decay time were measured to be about 5.6 ms and 4.1 ms, respectively, which are among the fastest PR materials reported. Advantageously, these response times can be achieved without resorting to a very high electric field, in excess of about 100V/μm, as expressed as biased voltage. For example, these fast response times can generally be achieved at biased voltages no higher than about 90 V/μm, and even no higher than about 80 V/μm.

### Examples 3 and 4

Photorefractive compositions were obtained in the same manner as in Example 1 except that TPD/CBZ/chromophore type copolymer prepared in production example 2 was used and gold nanoparticle weight percentage was changed to the ratio as described in Table 2. No metal nanoparticles were provided in Comparative Example 2.

TABLE 2
Photorefractive compositions using the matrix polymer of production example 2

| | Matrix | | | | | | |
|---|---|---|---|---|---|---|---|
| | polymer | | | | | | |
| | (mg) | | | Gold | Diffraction | Rising | Decay |
| | (production | FDCST | ECZ | nanoparticle | efficiency | time | time |
| Example | example 2) | (mg) | (mg) | (mg) | at 80 V/um | (ms) | (ms) |
| 3 | 50 | 30 | 20 | 0.25 | 100% | 45.9 | 21.4 |
| 4 | 50 | 30 | 20 | 0.1 | N/A | 72.6 | 41.8 |
| Comparative | 50 | 30 | 20 | 0 | 90% | 81.0 | 39.1 |
| Example 2 | | | | | | | |

As shown in Table 2, the response of the photorefractive composition having a range of gold particle concentrations indicates improvement in the rising and decay times over compositions without the particles. The rising times are found to be approximately 72.6 ms or less, 65 ms or less, 60 ms or less, 55 ms or less, 50 ms or less, and 46 ms or less. In percentage terms, the rising time is measured to be less than the comparative example by 10.5% or more, 15% or more, 20% or more, 25% or more, 30% or more, 35% or more, 40% or more, and 43%.

The decay times are found to be approximately 38 ms or less, 35 ms or less, 30 ms or less, 25 ms or less, and 21.4 ms or less. In percentage terms, the decay time is measured to be less than the comparative example by 5% or more, 10% or more, 20% or more, 30% or more, 40% or more, and 45% or more.

All literature references and patents mentioned herein are hereby incorporated in their entireties. Although the foregoing description has shown, described, and pointed out the fundamental novel features of the present teachings, it will be understood that various omissions, substitutions, and changes in the form of the detail of the apparatus as illustrated, as well as the uses thereof, can be made by those skilled in the art, without departing from the scope of the present teachings. Consequently, the scope of the present teachings should not be limited to the foregoing discussion, but should be defined by the appended claims.

What is claimed is:

1. A photorefractive composition, comprising:
a polymer; and
metal-containing nanoparticles;
wherein the polymer comprises a charge transport component and a non-linear optical component.

2. The composition of claim 1, wherein the metal-containing nanoparticles comprises:
at least one metal of gold, palladium, platinum, silver, and copper;
at least one oxide of gold, palladium, platinum, silver, and copper;
at least one alloy of gold, palladium, platinum, silver, and copper; and/or
mixtures thereof.

3. The composition of claim 2, wherein the metal-containing nanoparticles comprise gold or a gold alloy.

4. The composition of claim 1, further comprising at least one agent which inhibits agglomeration of the nanoparticles.

5. The composition of claim 4, wherein the agent comprises a sulfur containing ligand.

6. The composition of claim 5, wherein the sulfur containing ligand comprises a thiol.

7. The composition of claim 1, wherein the charge transport component comprises a recurring unit that comprises a moiety selected from the group consisting of the Structures (i), (ii), and (iii): 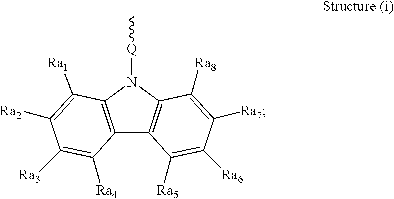 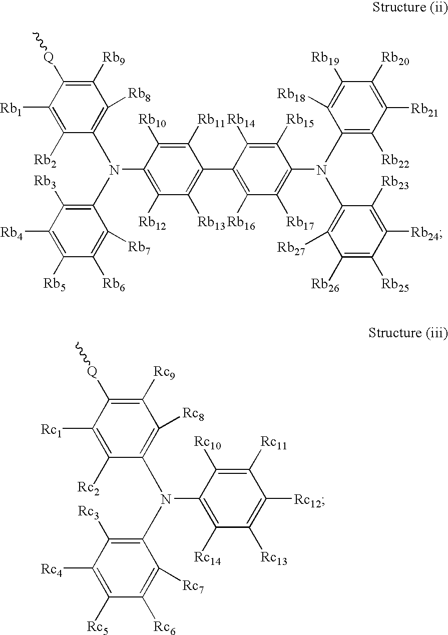
wherein each Q in Structures (i), (ii), and (iii) independently represents an alkylene group, with or without a hetero atom and Ra₁-Ra₈, Rb₁-Rb₂₇, and Rc₁-Rc₁₄ of Structures (i), (ii), and (iii) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

8. The composition of claim 1 wherein the non-linear optical component comprises a recurring unit that comprises a moiety comprising Structure (0): 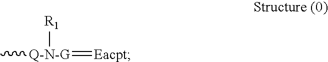
wherein Q in Structure (0) represents an alkylene group, with or without a hetero atom, G in Structure (0) is a group having a bridge of π-conjugated bond, Eacpt in Structure (0) is an electron acceptor group, and R₁ in Structure (0) is selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

9. The composition of claim 8, wherein G in Structure (0) is selected from the group consisting of the Structures (iv) and (v): 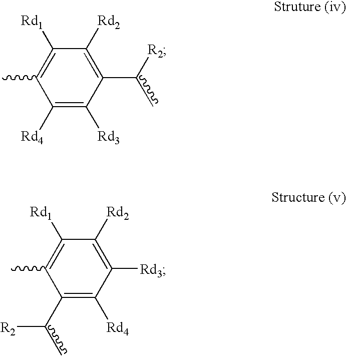
wherein each Rd₁-Rd₄ and R₂ in Structures (iv) and (v) are independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

10. The composition of claim 8, wherein Eacpt is represented by a structure selected from the group consisting of the structures: 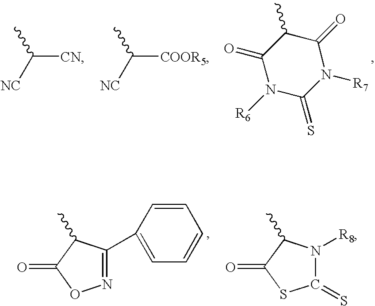
wherein R₅, R₆, R₇ and R₈ in the above compounds are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

11. A holographic data storage and image recording device comprising the photorefractive composition of claim 1.

12. A photorefractive composition, comprising:
nanoparticles comprising at least one of gold, palladium, platinum, silver, and copper; and
a first recurring unit including a first moiety selected from the group consisting of the Structures (i″), (ii″), and (iii″): 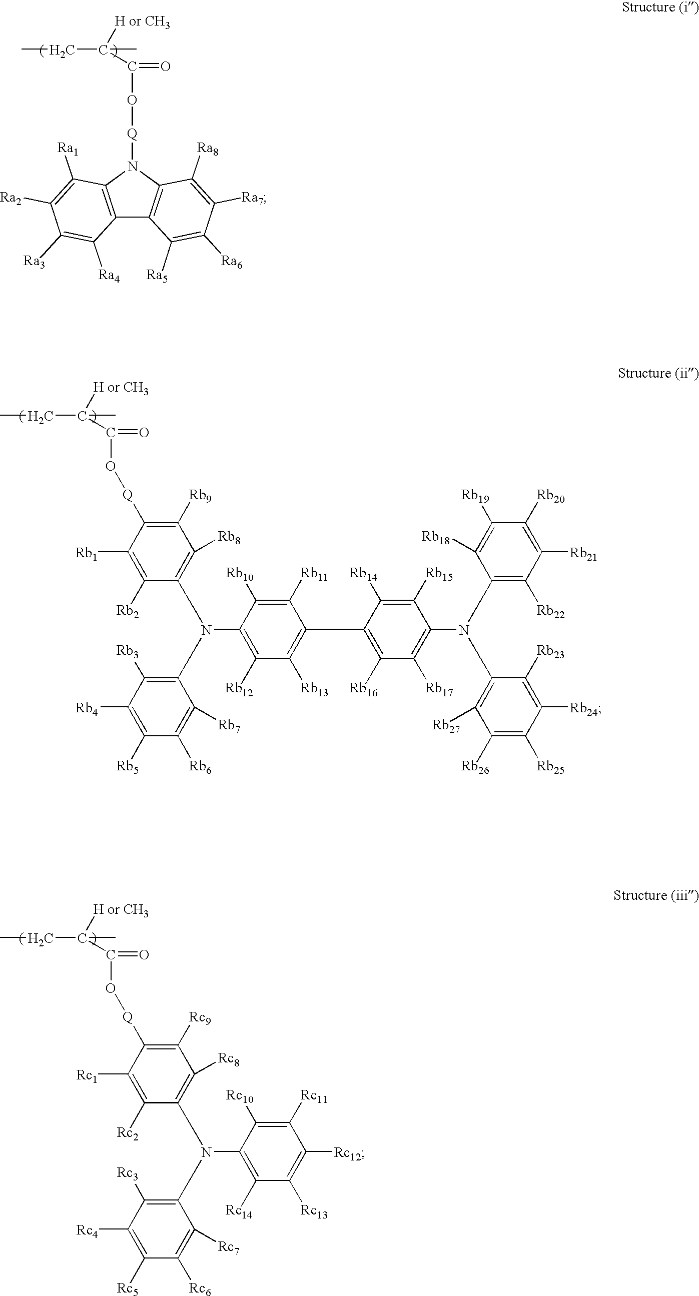
wherein each Q in Structures (i″), (ii″), and (iii″) independently represents an alkylene group, with or without a hetero atom and Ra₁-Ra₈, Rb₁-Rb₂₇, and Rc₁-Rc₁₄ in Structures (i″), (ii″), and (iii″) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

13. The composition of claim 12, further comprising a second recurring unit comprising a second moiety represented by the Structure (0″): 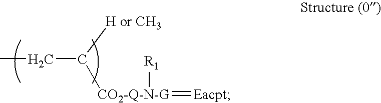
wherein Q in Structure (0″) represents an alkylene group, with or without a hetero atom, G in Structure (0″) is a group having a bridge of π-conjugated bond, Eacpt in Structure (0″) is an electron acceptor group, and R₁ in Structure (0″) is selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

14. The composition of claim 13, wherein G in Structure (0″) is selected from the group consisting of the Structures (iv) and (v): 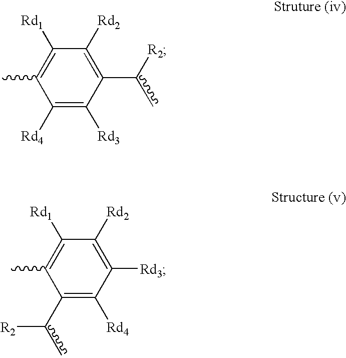
wherein Rd₁-Rd₄ and R₂ in Structures (iv) and (v) are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

15. The composition of claim 13, wherein Eacpt is represented by a structure selected from the group consisting of the structures: 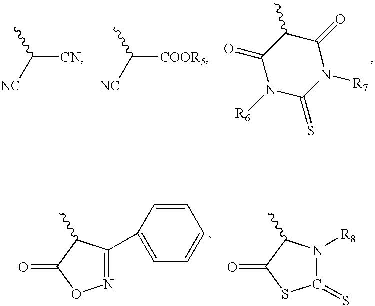
wherein R₅, R₆, R₇ and R₈ in the above compounds are each independently selected from the group consisting of a hydrogen atom, a C₁₋₁₀ linear alkyl group, a C₁₋₁₀ branched alkyl group, a C₅₋₁₀ aryl group, a heteroaryl group, an alkene group, an alkyne group, a cycloalkyl, a cycloalkene, a cycloalkyne, a heteroalkyl, a heteroalkenyl, and a heteroalkynyl.

16. A method of manufacturing an optical device, comprising:
providing an optical substrate; and depositing a photorefractive composition on at least one surface of the substrate as a film,
wherein the film has a thickness of about 10 μm to about 200 μm; and
wherein the photorefractive composition comprises metal-containing nanoparticles and a polymer having a charge transport component and a non-linear optical component.

17. The method of claim 16, wherein the metal-containing nanoparticles comprises:
at least one metal of gold, palladium, platinum, silver, and copper;
at least one oxide of gold, palladium, platinum, silver, and copper;
at least one alloy of gold, palladium, platinum, silver, and copper; and/or
mixtures thereof

18. The method of claim 16, wherein the metal-containing nanoparticles are present in a concentration from about 0.0001 wt % to about 20 wt % on the basis of the weight of the total composition
